(19) United States
(12) Patent Application Publication
(10) Pub. No.: US 2026/0107023 A1
(43) Pub. Date: Apr. 16, 2026

(54) DECODING METHOD, ENCODING METHOD, DECODER, AND ENCODER

(71) Applicant: GUANGDONG OPPO MOBILE TELECOMMUNICATIONS CORP., LTD., Dongguan (CN)

(72) Inventor: Zhenyu DAI, Dongguan (CN)

(73) Assignee: GUANGDONG OPPO MOBILE TELECOMMUNICATIONS CORP., LTD., Dongguan (CN)

(21) Appl. No.: 19/418,613

(22) Filed: Dec. 12, 2025

Related U.S. Application Data
(63) Continuation of application No. PCT/CN2023/100814, filed on Jun. 16, 2023.

(51) Int. Cl. H04N 19/82; H04N 19/117; H04N 19/147; H04N 19/176; H04N 19/196

(52) U.S. Cl. CPC H04N 19/82; H04N 19/117; H04N 19/147; H04N 19/176; H04N 19/198

(57) ABSTRACT

The present application provides a decoding method, an encoding method, a decoder, and an encoder. The decoding method comprises: filtering a reconstructed block of a current block to obtain a first filtered block; determining a first residual block on the basis of the first filtered block and the reconstructed block; adjusting a direct-current component of the first residual block to obtain a second residual block; and determining a final reconstructed block on the basis of the second residual block and the reconstructed block.

### CROSS-REFERENCE TO RELATED APPLICATIONS

This application is a continuation of International Application No. PCT/CN2023/100814, filed on Jun. 16, 2023, the disclosure of which is hereby incorporated by reference in its entirety.

### TECHNICAL FIELD

This application relates to the field of encoding and decoding technologies, and more specifically, to a decoding method, an encoding method, a decoder, and an encoder.

### BACKGROUND

Digital video compression technologies mainly compress huge amounts of digital image and video data, to facilitate transmission and storage.

With explosive growth of internet videos and an increasingly high demand of people for a video resolution, although existing digital video compression standards can significantly reduce amounts of video data to be transmitted, it is necessary to develop more advanced digital video compression technologies to alleviate bandwidth and traffic pressure during digital video transmission.

To improve decoding performance, after determining a reconstructed image based on a bitstream, a decoder needs to perform in-loop filtering on the reconstructed image, to obtain a decoded image. The decoded image may be used as a reference frame for prediction of subsequent images. In-loop filtering mainly processes samples subjected to inverse transform and inverse quantization, to compensate for distortion information, thereby providing better reference for subsequent images. A conventional in-loop filtering unit configured to perform in-loop filtering mainly includes tools such as a deblocking (DeBlocking) filter (DBF), a sample adaptive offset (SAO) filter, and an adaptive loop filter (ALF).

However, with development of technologies, more advanced filtering technologies still need to be developed to improve decoding performance.

### SUMMARY

This application provides a decoding method, an encoding method, a decoder, and an encoder to improve decoding performance.

According to a first aspect, this application provides a decoding method, including:
filtering a reconstructed block of a current block, to obtain a first filtered block;
determining a first residual block based on the first filtered block and the reconstructed block;
adjusting a direct current component of the first residual block, to obtain a second residual block; and
determining a final reconstructed block of the current block based on the second residual block and the reconstructed block.

According to a second aspect, this application provides an encoding method, including:
filtering a reconstructed block of a current block, to obtain a first filtered block;
determining a first residual block based on the first filtered block and the reconstructed block;
adjusting a direct current component of the first residual block, to obtain a second residual block;
determining a second filtered block based on the second residual block and the reconstructed block; and
determining a filtered image with a smaller rate distortion cost among a first filtered image to which the first filtered block belongs and a second filtered image to which the second filtered block belongs, as a reconstructed image of a current image to which the current block belongs.

According to a third aspect, this application provides a decoder, including:
a filtering unit, configured to filter a reconstructed block of a current block, to obtain a first filtered block;
a first determining unit, configured to determine a first residual block based on the first filtered block and the reconstructed block;
an adjustment unit, configured to adjust a direct current component of the first residual block, to obtain a second residual block; and
a second determining unit, configured to determine a final reconstructed block of the current block based on the second residual block and the reconstructed block.

According to a fourth aspect, this application provides an encoder, including:
a filtering unit, configured to filter a reconstructed block of a current block, to obtain a first filtered block;
a first determining unit, configured to determine a first residual block based on the first filtered block and the reconstructed block;
an adjustment unit, configured to adjust a direct current component of the first residual block, to obtain a second residual block;
a second determining unit, configured to determine a second filtered block based on the second residual block and the reconstructed block; and
a third determining unit, configured to determine a filtered image with a smaller rate distortion cost among a first filtered image to which the first filtered block belongs and a second filtered image to which the second filtered block belongs, as a reconstructed image of a current image to which the current block belongs.

According to a fifth aspect, this application provides a decoder, including:
a processor, adapted to implement a computer instruction; and
a computer-readable storage medium, where the computer-readable storage medium stores a computer instruction, and the computer instruction is adapted to be loaded by the processor to execute the decoding method according to the first aspect or implementations of the first aspect.

In an implementation, there are one or more processors and one or more memories.

In an implementation, the computer-readable storage medium may be integrated with the processor, or the computer-readable storage medium may be disposed separately from the processor.

According to a sixth aspect, this application provides an encoder, including:
a processor, adapted to implement a computer instruction; and
a computer-readable storage medium, where the computer-readable storage medium stores a computer instruction, and the computer instruction is adapted to be loaded by the processor to execute the encoding method according to the second aspect or implementations of the second aspect.

In an implementation, there are one or more processors and one or more memories.

In an implementation, the computer-readable storage medium may be integrated with the processor, or the computer-readable storage medium may be disposed separately from the processor.

According to a seventh aspect, this application provides a computer-readable storage medium. The computer-readable storage medium stores a computer instruction; and when being read and executed by a processor of a computer device, the computer instruction causes the computer device to execute the decoding method according to the first aspect or the encoding method according to the second aspect.

According to an eighth aspect, this application provides a computer program product or a computer program, where the computer program product or the computer program includes a computer instruction, and the computer instruction is stored in a computer-readable storage medium. A processor of a computer device reads the computer instruction from the computer-readable storage medium and executes the computer instruction, to cause the computer device to execute the decoding method according to the first aspect or the encoding method according to the second aspect.

According to a ninth aspect, this application provides a bitstream, where the bitstream is a bitstream related to the method according to the first aspect or a bitstream generated by using the method according to the second aspect.

Based on the foregoing technical solutions, according to the decoding method provided in this application, a first residual block is determined based on a reconstructed block of a current block and a first filtered block obtained by filtering the reconstructed block of the current block. A direct current component of the first residual block is adjusted, to obtain a second residual block, and a final reconstructed block of the current block is determined based on the second residual block and the reconstructed block.

### BRIEF DESCRIPTION OF DRAWINGS

FIG. 1 is a schematic block diagram of a video encoding and decoding system according to an embodiment of this application.

FIG. 2 is a schematic block diagram of a video encoder according to an embodiment of this application.

FIG. 3 is a schematic structural diagram of a relationship between a coding tree unit and a coding unit according to this application.

FIG. 4 is a schematic block diagram of a video decoder according to an embodiment of this application.

FIG. 5 is another example of a video encoder according to this application.

FIG. 6 is an example of a basic structure of a residual network according to this application.

FIG. 7 is an example of a basic structure of an NNLF according to this application.

FIG. 8 is an example of a basic structure of an LC NNLF according to this application.

FIG. 9 is another example of a video encoder according to this application.

FIG. 10 is a schematic flowchart of a decoding method according to this application.

FIG. 11 is an example of a principle of determining a first residual block according to this application.

FIG. 12 is an example of a to-be-corrected residual image according to this application.

FIG. 13 is an example of a first residual block according to this application.

FIG. 14 is an example of a second residual block according to this application.

FIG. 15 is an example of a size of an image block for which a residual value is adjusted according to this application.

FIG. 16 is an example of a sliding window according to this application.

FIG. 17 is a schematic flowchart of an encoding method according to this application.

FIG. 18 is a schematic block diagram of a decoder according to this application.

FIG. 19 is a schematic block diagram of an encoder according to this application.

FIG. 20 is a schematic block diagram of an electronic device according to this application.

### DESCRIPTION OF EMBODIMENTS

The solutions provided in this application may be applied to the field of digital compression technologies.

Digital video compression technologies mainly compress huge amounts of digital image and video data, to facilitate transmission and storage.

The solutions provided in this application may be applied to the field of digital video coding technologies.

The field of digital video coding technologies includes but is not limited to at least one of the following: the field of image encoding and decoding, the field of video encoding and decoding, the field of hardware video encoding and decoding, the field of dedicated circuit video encoding and decoding, or the field of real-time video encoding and decoding. In addition, the solutions provided in this application may be combined with the following standard: an audio video coding standard (AVS), a second-generation AVS standard (AVS2), or a third-generation AVS standard (AVS3), which, for example, includes but is not limited to an H.264/audio video coding (AVC) standard, an H.265/high efficiency video coding (HEVC) standard, and an H.266/versatile video coding (VVC) standard. In addition, the solutions provided in this application may be used to perform lossy compression or lossless compression on an image. The lossless compression may be visually lossless compression or mathematically lossless compression.

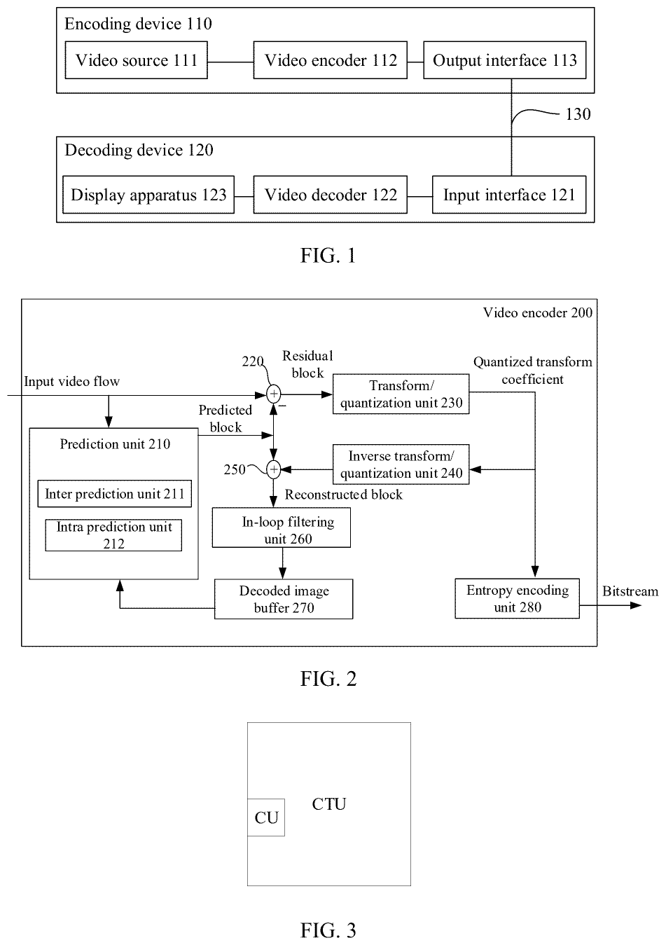

For ease of understanding, a video encoding and decoding system according to an embodiment of this application is first described with reference to FIG. 1.

FIG. 1 is a schematic block diagram of a video encoding and decoding system according to an embodiment of this application.

As shown in FIG. 1, the video encoding and decoding system 100 includes an encoding device 110 and a decoding device 120.

The encoding device 110 is configured to perform encoding (which may be understood as compression) on video data, to generate a bitstream, and transmit the bitstream to the decoding device 120. The decoding device 120 decodes the bitstream generated by encoding of the encoding device 110, to obtain decoded video data.

The encoding device 110 may be understood as a device having a video encoding function, and the decoding device 120 may be understood as a device having a video decoding function. That is, in embodiments of this application, the encoding device 110 and the decoding device 120 include apparatuses in a broader sense, such as a smartphone, a desktop computer, a mobile computing apparatus, a notebook computer (for example, a laptop computer), a tablet computer, a set-top box, a television, a camera, a display apparatus, a digital media player, a video game console, and a vehicle-mounted computer.

The encoding device 110 may transmit encoded video data (for example, a bitstream) to the decoding device 120 through a channel 130.

The channel 130 may include one or more media and/or apparatuses capable of transmitting the encoded video data from the encoding device 110 to the decoding device 120.

The channel 130 may include one or more communications media that enable the encoding device 110 to directly transmit the encoded video data to the decoding device 120 in real time. The encoding device 110 may modulate the encoded video data according to a communication standard, and transmit the modulated video data to the decoding device 120. The communications media include a wireless communications medium, for example, a radio frequency spectrum. The communications media may also include a wired communications medium, for example, one or more physical transmission lines.

The channel 130 may include a storage medium, where the storage medium may store the video data encoded by the encoding device 110. The storage medium includes a plurality of locally accessed data storage media, such as an optical disc, a DVD, and a flash memory. In this example, the decoding device 120 may acquire the encoded video data from the storage medium.

The channel 130 may include a storage server, where the storage server may store the video data encoded by the encoding device 110. In this example, the decoding device 120 may download the stored encoded video data from the storage server. Optionally, the storage server may store the encoded video data and transmit the encoded video data to the decoding device 120 by using, for example, a web server (for example, a website) or a file transfer protocol (FTP) server. The encoding device 110 includes a video encoder 112 and an output interface 113.

The output interface 113 may include a modulator/demodulator (modem) and/or a transmitter. The video encoder 112 directly transmits the encoded video data to the decoding device 120 through the output interface 113. The encoded video data may alternatively be stored in the storage medium or the storage server, to be subsequently read by the decoding device 120.

In addition to the video encoder 112 and the input interface 113, the encoding device 110 may further include a video source 111.

The video source 111 may include at least one of a video collection apparatus (for example, a video camera), a video archive, a video input interface, or a computer graphics system. The video input interface is configured to receive video data from a video content provider, and the computer graphics system is configured to generate video data. The video encoder 112 encodes video data from the video source 111, to generate a bitstream. The video data may include one or more images (picture) or image sequences (sequence of pictures). The bitstream includes coding information of an image or an image sequence in a form of a bit stream. The coding information may include coding image data and associated data. The associated data may include a sequence parameter set (SPS), a picture parameter set (PPS), and another syntax structure. The SPS may include a parameter applied to one or more sequences. The PPS may include a parameter applied to one or more images. A syntax structure refers to a set of zero or more syntax elements arranged in a specified order in the bitstream.

The decoding device 120 includes an input interface 121 and a video decoder 122. The input interface 121 may include a receiver and/or a modem.

In addition to the input interface 121 and the video decoder 122, the decoding device 120 may further include a display apparatus 123.

The input interface 121 may receive the encoded video data through the channel 130. The video decoder 122 is configured to decode the encoded video data, to obtain decoded video data, and transmit the decoded video data to the display apparatus 123. The display apparatus 123 displays the decoded video data. The display apparatus 123 may be integrated with the decoding device 120 or located outside the decoding device 120. The display apparatus 123 may include a plurality of display apparatuses, such as a liquid crystal display (LCD), a plasma display, an organic light-emitting diode (OLED) display, or another type of display apparatus.

It should be understood that FIG. 1 is merely an example of this application and shall not be understood as a limitation to this application. That is, the technical solutions in embodiments of this application are not limited to the system framework shown in FIG. 1. For example, the technical solutions in this application may also be applied to only video encoding or only video decoding.

The following describes a video encoding framework related to embodiments of this application.

FIG. 2 is a schematic block diagram of a video encoder 200 according to an embodiment of this application.

It should be understood that the video encoder 200 may be applied to image data in a luma-chroma (YCbCr, YUV) format. For example, a YUV ratio may be 4:2:0, 4:2:2, or 4:4:4, Y represents luma, Cb (U) represents blue chroma, Cr (V) represents red chroma, and U and V represent chroma for describing a color and saturation. For example, in a color format, 4:2:0 represents that every four samples have four luma components and two chroma components (YYYYCbCr), 4:2:2 represents that every four samples have four luma components and four chroma components (YYYYCbCrCbCr), and 4:4:4 represents full sample display (YYYYCbCrCbCrCbCrCbCr). Certainly, the video encoder 200 may also be applied to image data in a red-green-blue (Red-Green-Blue, RGB) format. This is not specifically limited in this application.

After reading a video flow, the video encoder 200 may partition each frame of image in the video flow into several coding tree units (CTU). In some examples, the CTU may be referred to as a “tree block”, a “largest coding unit (LCU)”, or a “coding tree block (CTB)”. Each CTU may be associated with sample blocks of a same size in an image. Each sample may correspond to one luma (luminance or luma) sample and two chroma (chrominance or chroma) samples. Therefore, each CTU may be associated with one luma sampling block and two chroma sampling blocks. A size of a CTU may be, for example, 128×128, 64×64, or 32×32. FIG. 3 is a schematic structural diagram of a relationship between a coding tree unit and a coding unit according to this application. As shown in FIG. 3, a CTU may be further partitioned into several coding units (CU) for encoding, and the CU may be a rectangular block or a square block. The CU may be further partitioned into a prediction unit (PU) and a transform unit (TU), so that encoding, prediction, transform, and separation are performed more flexibly. In an example, the CTU is partitioned into CUs in a form of a tree (for example, a quadtree), and the CU is partitioned into a TU and a PU in a form of a tree (for example, a quadtree).

Video encoders and video decoders can support various PU sizes.

Assuming that a size of a specific CU is 2N×2N, video encoders and video decoders can support PUs of a size of 2N×2N or N×N for intra prediction and symmetrical PUs of a size such as 2N×2N, 2N×N, N×2N, N×N, or the like for inter prediction. Video encoders and video decoders can also support asymmetric PUs of a size such as 2N×nU, 2N×nD, nL×2N, or nR×2N for inter prediction.

As shown in FIG. 2, the video encoder 200 may include a prediction unit 210, a residual unit 220, a transform/quantization unit 230, an inverse transform/quantization unit 240, a reconstruction unit 250, an in-loop filtering unit 260, a decoded image buffer 270, and an entropy encoding unit 280. It should be noted that the video encoder 200 may include more, fewer, or different functional components. In this application, a current block may be referred to as a current coding unit (CU), a current prediction unit (PU), or the like. A predicted block may also be referred to as a predicted image block or an image prediction block, and a reconstructed image block may also be referred to as a reconstructed block or an image reconstruction block.

The prediction unit 210 includes an inter prediction unit 211 and an intra prediction unit 212. Due to strong correlation between adjacent samples in an image of a video, spatial redundancy between adjacent samples is eliminated by using an intra prediction method in video encoding and decoding technologies. Due to strong similarity between adjacent images in a video, time redundancy between adjacent images is eliminated by using an inter prediction method, thereby improving encoding efficiency.

The inter prediction unit 211 may be configured to perform inter prediction, which may include motion estimation and motion compensation. Reference may be made to information about different frames of image. In inter prediction, motion information is used to find a reference block from a reference frame, and a predicted block is generated according to the reference block, to eliminate time redundancy. The reference frame may be a P-frame and/or a B-frame, where the P-frame refers to a predictive-coded frame, and the B-frame refers to a bidirectionally predictive-coded frame. In inter prediction, after the reference block is found by using the motion information, the predicted block is generated according to the reference block. The motion information includes a frame list to which the reference frame belongs, a frame index, and a motion vector. The motion vector may be an integer-sample motion vector or a sub-sample motion vector. In a case that the motion vector is a sub-sample motion vector, a required sub-sample block needs to be obtained from the reference frame by using interpolation filtering, and the reference block is an integer-sample block or a sub-sample block found according to the motion vector. Some technologies directly use the reference block as a predicted block, and some technologies process the reference block to generate the predicted block. Processing the reference block to generate the predicted block may also be understood as: using the reference block as the predicted block and processing the predicted block to generate a new predicted block.

The intra prediction unit 212 predicts sample information in a current coding image block by referring to only information about a same frame of image, to eliminate spatial redundancy. A reference frame used for intra prediction may be an I-frame.

There are a plurality of intra prediction modes. A to-be-encoded image block may be predicted by using an angular prediction mode or a non-angular (Non-angle) prediction mode, to obtain a predicted block. Then, an optimal prediction mode of the to-be-encoded image block is selected based on rate distortion information calculated according to the predicted block and the to-be-encoded image block, and the prediction mode is written into a bitstream and transmitted to a decoding end. The decoding end obtains the prediction mode by parsing, obtains a predicted block of a target decoding block by prediction, and adds the predicted block to a time domain residual block acquired based on the bitstream, to obtain a reconstructed block.

The international digital video coding standard H series is used as an example. The H.264/AVC standard provides eight angular prediction modes and one non-angular (Non-angle) prediction mode. H.265/HEVC extends prediction modes to 33 angular prediction modes and two non-angular (Non-angle) prediction modes. Intra prediction modes used in HEVC include a planar mode, a direct current (DC) mode, and 33 angular modes, that is, a total of 35 prediction modes. Intra prediction modes used in VVC include a planar mode, a DC mode, and 65 angular modes, that is, a total of 67 prediction modes. These prediction modes include conventional prediction modes and non-conventional prediction modes. The non-conventional prediction modes may include a matrix weighted intra prediction (MIP) mode. The conventional prediction modes include a planar mode with a mode number of 0, a DC mode with a mode number of 1, and angular prediction modes with mode numbers of 2 to 66. It should be noted that, as a quantity of angular modes increases, an intra prediction result becomes more accurate and better meets a requirement for developing high-definition and ultra-high-definition digital videos. The foregoing intra prediction modes are merely examples of this application and shall not be construed as a limitation to this application.

The residual unit 220 may generate a residual block of a CU based on a sample block of the CU and a predicted block of a PU of the CU. For example, the residual unit 220 may generate the residual block of the CU, so that each sample in the residual block has a value equal to a difference between a sample in a sample block of the CU and a corresponding sample in the predicted block of the PU of the CU.

The transform/quantization unit 230 may quantize a transform coefficient. The transform/quantization unit 230 may quantize a transform coefficient associated with a TU of the CU by using a quantization parameter (QP) value associated with the CU. The video encoder 200 may adjust a degree of quantization applied to the transform coefficient associated with the CU by adjusting the QP value associated with the CU.

The inverse transform/quantization unit 240 may apply inverse quantization and inverse transform to the quantized transform coefficient, to reconstruct a residual block from the quantized transform coefficient.

The reconstruction unit 250 may add a sample of the reconstructed residual block to a sample corresponding to one or more predicted blocks generated by the prediction unit 210, to generate a reconstructed image block associated with the TU. In this way, a sampling block of each TU of the CU is reconstructed, and the video encoder 200 can reconstruct a sample block of the CU.

The in-loop filtering unit 260 is configured to process samples subjected to inverse transform and inverse quantization, to compensate for distortion information, thereby providing better reference for subsequent coding samples. For example, the in-loop filtering unit 260 may execute a deblocking filtering operation to reduce blocking artifacts of a sample block associated with the CU. In some embodiments, the in-loop filtering unit 260 includes a deblocking (DeBlocking) filter (DBF) unit and a sample adaptive offset/adaptive loop filter (SAO/ALF) unit. The DBF unit is configured to remove blocking artifacts, and the SAO/ALF unit is configured to remove ringing artifacts.

The decoded image buffer 270 may store reconstructed sample blocks.

The inter prediction unit 211 may execute inter prediction on a PU of another image by using a reference image that is in the decoded image buffer 270 and that includes a reconstructed sample block. In addition, the intra prediction unit 212 may execute intra prediction on another PU in a same image as the CU by using a reconstructed sample block in the decoded image buffer 270.

The entropy encoding unit 280 may receive the quantized transform coefficient from the transform/quantization unit 230. The entropy encoding unit 280 may execute one or more entropy encoding operations on the quantized transform coefficient, to generate entropy encoded data.

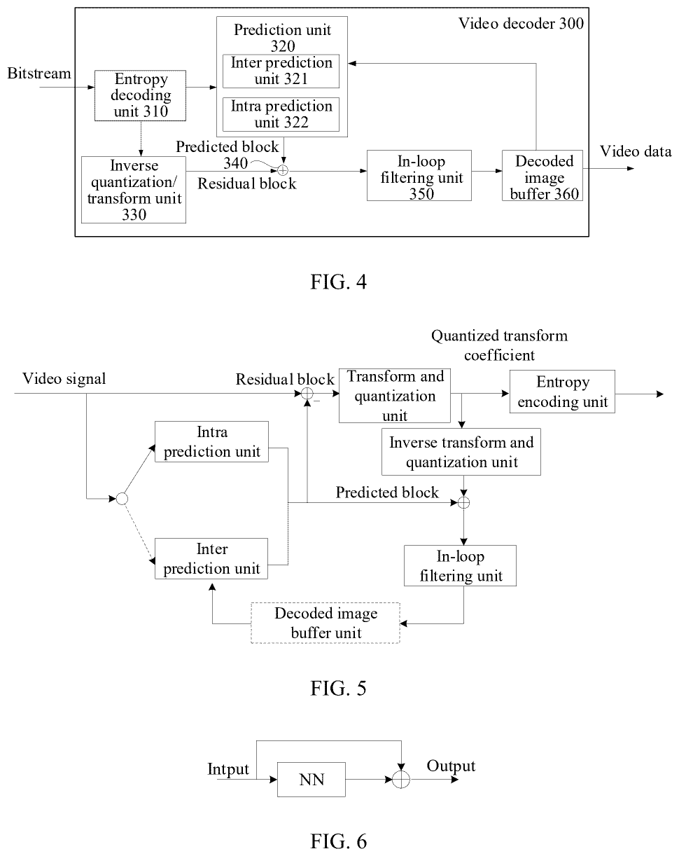

FIG. 4 is a schematic block diagram of a video decoder according to an embodiment of this application.

As shown in FIG. 4, the video decoder 300 includes an entropy decoding unit 310, a prediction unit 320, an inverse quantization/transform unit 330, a reconstruction unit 340, an in-loop filtering unit 350, and a decoded image buffer 360. It should be noted that the video decoder 300 may include more, fewer, or different functional components.

The video decoder 300 may receive a bitstream. The entropy decoding unit 310 may parse the bitstream, to extract syntax elements from the bitstream. As a part of parsing the bitstream, the entropy decoding unit 310 may parse entropy encoded syntax elements in the bitstream. The prediction unit 320, the inverse quantization/transform unit 330, the reconstruction unit 340, and the in-loop filtering unit 350 may decode video data according to the syntax elements extracted from the bitstream, that is, generate decoded video data.

The prediction unit 320 includes an intra prediction unit 322 and an inter prediction unit 321.

The intra prediction unit 322 may execute intra prediction, to generate a predicted block of a PU. The intra prediction unit 322 may generate the predicted block of the PU by using an intra prediction mode based on sample blocks of spatially adjacent PUs. The intra prediction unit 322 may further determine an intra prediction mode of the PU according to one or more syntax elements obtained by parsing the bitstream.

The inter prediction unit 321 may construct a first reference image list (list 0) and a second reference image list (list 1) according to the syntax elements obtained by parsing the bitstream. In addition, in a case that inter prediction coding is used for the PU, the entropy decoding unit 310 may parse motion information of the PU. The inter prediction unit 321 may determine one or more reference blocks of the PU according to the motion information of the PU. The inter prediction unit 321 may generate a predicted block of the PU according to the one or more reference blocks of the PU.

The inverse quantization/transform unit 330 may inversely quantize (that is, dequantize) a transform coefficient associated with a TU. The inverse quantization/transform unit 330 may determine a degree of quantization by using a QP value associated with a CU of the TU. After the transform coefficient is inversely quantized, the inverse quantization/transform unit 330 may apply one or more inverse transforms to the inversely quantized transform coefficient, to generate a residual block associated with the TU.

The reconstruction unit 340 reconstructs a sample block of the CU by using the residual block associated with the TU of the CU and a predicted block of a PU of the CU. For example, the reconstruction unit 340 may add a sample of the residual block to a corresponding sample of the predicted block, to reconstruct the sample block of the CU, so as to obtain a reconstructed image block.

The in-loop filtering unit 350 may execute a deblocking filtering operation, to reduce block artifacts of the sample block associated with the CU.

The video decoder 300 may store a reconstructed image of the CU in the decoded image buffer 360. The video decoder 300 may use the reconstructed image in the decoded image buffer 360 as a reference image for subsequent prediction or transmit the reconstructed image to a display apparatus for display.

With reference to FIG. 2 and FIG. 4, a basic procedure of video encoding and decoding is as follows.

At an encoding end, a frame of image is partitioned into image blocks. For a current block, the prediction unit 210 obtains a predicted block of the current block (that is, a to-be-encoded block) by performing intra prediction or inter prediction. The residual unit 220 may calculate, based on the predicted block and an original block of the current block (that is, the to-be-encoded block), a residual block, that is, a difference between the predicted block and the original block. The residual block may also be referred to as residual information. The transform/quantization unit 230 may perform processing such as transform and quantization on the residual block, to remove information insensitive to human eyes, thereby eliminating visual redundancy. Optionally, a residual block not subjected to transform and quantization of the transform/quantization unit 230 may be referred to as a time domain residual block, and a time domain residual block subjected to transform and quantization of the transform/quantization unit 230 may be referred to as a frequency residual block or a frequency domain residual block. After receiving a quantized transform coefficient output by the transform/quantization unit 230, the entropy encoding unit 280 may perform entropy encoding on the quantized transform coefficient, to output a bitstream. For example, the entropy encoding unit 280 may eliminate character redundancy according to a target context model and probability information of a binary bitstream.

At a decoding end, the entropy decoding unit 310 may parse a bitstream, to obtain prediction information of a current block (that is, a to-be-decoded block), a quantization coefficient matrix, and the like. The prediction unit 320 obtains a predicted block of the current block (that is, the to-be-decoded block) based on the prediction information and by performing intra prediction or inter prediction. The inverse quantization/transform unit 330 performs inverse quantization and inverse transform on the quantization coefficient matrix obtained from the bitstream, to obtain a residual block. The reconstruction unit 340 adds the predicted block and the residual block, to obtain a reconstructed block. Reconstructed blocks form a reconstruction image, and the in-loop filtering unit 350 performs in-loop filtering on the reconstruction image on a per-image basis or on a per-block basis, to obtain a decoded image. It should be noted that the encoding end needs to perform operations similar to operations of a decoder, to obtain a decoded image. The decoded image may also be referred to as a reconstructed image, and the reconstructed image may be used as a reference frame for inter prediction of subsequent frames.

In addition, block partitioning information determined by an encoder, mode information such as prediction, transform, quantization, entropy encoding, and in-loop filtering, or parameter information are carried in the bitstream if necessary. The decoding end determines, by parsing the bitstream or analyzing based on existing information, block partitioning information, mode information such as prediction, transform, quantization, entropy encoding, and in-loop filtering, or parameter information that is the same as the information at the encoding end. This ensures that a decoded image obtained by the encoder is the same as a decoded image obtained by the decoder.

It should be noted that, as required by parallel processing, an image may be partitioned into slices or the like, and the slices in the same image may be processed in parallel, that is, data of different slices is independent from each other. The term “frame” may be understood as an image, a slice, or the like. In addition, a basic procedure of a video codec in a block-based encoding and decoding framework is described above. With development of technologies, some modules of the framework or some steps of the procedure may be omitted, that is, this application is not limited to the framework and the procedure described above.

FIG. 5 is another example of a video encoder according to this application.

As shown in FIG. 5, the encoder reads unequal samples from video signals (for example, a video sequence) in different color formats. The sample includes a luma component and a chroma component, that is, the encoder reads a black and white image or a color image. Then, the encoder partitions the image into blocks and encodes the blocks. The encoder generally uses a hybrid encoding framework and includes a prediction unit (including an intra prediction unit and an inter prediction unit), a transform and quantization unit, an inverse transform and quantization unit, an in-loop filtering unit, an entropy encoding unit, and the like. Optionally, the encoder may further include a decoded image buffer unit. The intra prediction unit is configured to perform intra prediction. In intra prediction, sample information in a current block is predicted by referring to only information about a same frame of image, to eliminate spatial redundancy. The inter prediction unit is configured to perform inter prediction. In inter prediction, motion vector (MV) information that best matches a current block may be searched for by using motion estimation (ME) and by referring to information about different frames of image, to eliminate time redundancy. The transform and quantization unit is configured to perform transform and quantization. In transform, a predicted image block is converted into a frequency domain, and energy is redistributed. In combination with quantization, information insensitive to human eyes can be removed, to eliminate visual redundancy. The entropy encoding unit is configured to perform entropy encoding. In entropy encoding, character redundancy may be eliminated according to a current context model and probability information of a binary bitstream. The in-loop filtering unit is configured to perform in-loop filtering. In-loop filtering mainly processes samples subjected to inverse transform and inverse quantization, to compensate for distortion information, thereby providing better reference for subsequent coding samples.

Generally, the in-loop filtering unit mainly includes tools such as a deblocking (DeBlocking) filter (DBF), a sample adaptive offset (SAO) filter, and an adaptive loop filter (ALF). In recent years, with development of deep learning technologies, neural network based loop filters (NNLF) have been gradually explored.

The following describes contents related to in-loop filtering.

### (1) Baseline NNLF

For in-loop filtering, after years of research and optimization, an NNLF is used as a baseline filtering tool for neural network based common software (NCS) of neural network based video coding (NNVC) and is referred to as a low complexity neural network based loop filter (LC NNLF).

### (2) Residual Network

In the field of deep learning, a concept of residual learning is proposed for residual networks (ResNet).

FIG. 6 is an example of a basic structure of a residual network according to this application.

As shown in FIG. 6, the residual network includes a neural network (NN), and a skip connection structure is provided between an input and an output of the NN. The skip connection structure enables the NN to concentrate on learning of residual information of an image, thereby improving a learning capability and prediction performance of the NN. Specifically, the NN outputs predicted residual information, and adds the residual information to an input of the NN, to obtain an output of the residual network.

Due to excellent performance of residual networks, the concept of residual learning is introduced into a current baseline LC NNLF solution.

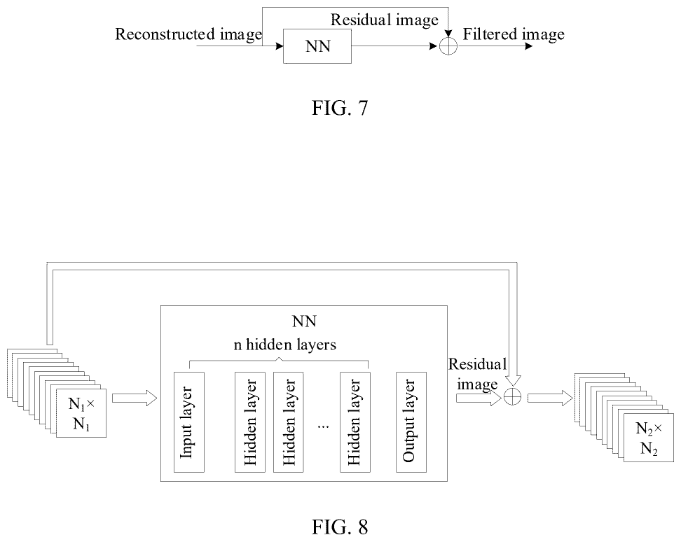

FIG. 7 is an example of a basic structure of an NNLF according to this application.

As shown in FIG. 7, a basic structure of the NNLF includes a skip connection branch from an input reconstructed block to an output filtered block. The output filtered block may be represented by the following formula:

$$cnn = rec + res .$$

Herein, cnn represents an output filtered block, rec represents an input reconstructed block, and res represents a residual block output by a neural network.

The NNLF is essentially as follows.

First, a residual block is predicted by using a reconstructed block input by an NN, and finally, the residual block is added to an input reconstructed block by using a simple addition operation, to output a filtered block, so that quality of the filtered block is closer to quality of an original block.

Therefore, the NNLF has a function of predicting residual blocks.

FIG. 8 is an example of a basic structure of an LC NNLF according to this application.

As shown in FIG. 8, the LC NNLF may be a residual network. That is, the LC NNLF includes an NN and a skip connection structure. Assuming that a reconstructed block is a block with a size of N₁×N₁, luma and chroma information of the reconstructed block and a plurality of types of auxiliary information are inputted to the NN, to obtain an output of the NN, that is, a residual block. The auxiliary information includes but is not limited to deblocking (DeBlocking) filtering boundary strength information, quantization parameter (QP) information, and the like. After the residual block is obtained, the residual block is added to the reconstructed block by using a skip connection structure, to obtain a filtered block. For example, the filtered block may be a block with a size of N₂×N₂.

The LC NNLF well balances encoding performance with complexity and therefore is used as a current baseline filtering tool.

In video encoding, when a reconstructed block is filtered by using an NNLF, a prediction capability is learned based on a large quantity of blocks and videos and millions of times of network training. However, the NNLF is considered as a black box with a multi-layer network structure to a large extent. Therefore, a residual block lacks reasonable interpretability to a specific extent. In this case, a residual value in a predicted residual block may be less than or greater than a real residual value, resulting in that the residual value is uncertain. Therefore, the residual value in the residual block needs to be corrected. However, in a case that the residual value in the predicted residual block is independently increased or decreased, a correcting effect for the residual value may be not good. In other words, a solution for properly correcting a residual block obtained by network prediction is urgently needed in the art.

In view of this, this application provides a decoding method, an encoding method, a decoder, and an encoder. A residual block output by a neural network based loop filter is modified, so that filtering performance of the neural network based loop filter can be optimized, thereby improving decoding performance of a decoder.

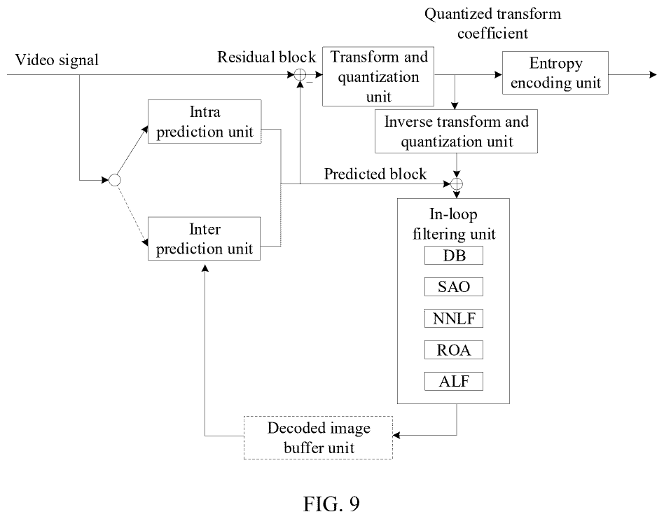

FIG. 9 is another example of a video encoder according to this application.

As shown in FIG. 9, the video encoder may include an in-loop filtering unit, and the in-loop filtering unit may include an NNLF and a residual offset adjustment (ROA) unit. The ROA unit may be used regardless of whether a DB, an SAO, or an ALF is turned on. In an example, the ROA unit may be located after the NNLF and before an ALF. It should be noted that this application sets no specific limitation to a specific location of the ROA unit and/or a usage sequence of filters.

The NNLF is any type of neural network based loop filter. For example, the NNLF may be the NNLF shown in FIG. 7 or FIG. 8.

The ROA unit is configured to adjust or correct a residual value in a residual block obtained by using an output and an input of the NNLF. At an encoding end, a rate distortion cost of a filtered block output by the NNLF relative to an original block is compared with a rate distortion cost of a filtered block subjected to residual adjustment relative to the original block, to determine whether to adjust or correct the residual value in the residual block obtained by using the output and the input of the NNLF. In other words, it is determined whether the filtered block output by the NNLF is used as a final reconstructed block, or the filtered block that is subjected to residual adjustment and that is output by the NNLF is used as the final reconstructed block. The selected filtered block is encoded into a bitstream for reading by a decoder. At a decoding end, after the actually used filtered block is obtained by parsing, the reconstructed block is filtered.

It should be understood that, for units except the in-loop filtering unit in FIG. 9, reference may be made to related descriptions of FIG. 2 or FIG. 5. To avoid repetition, details are not described herein again.

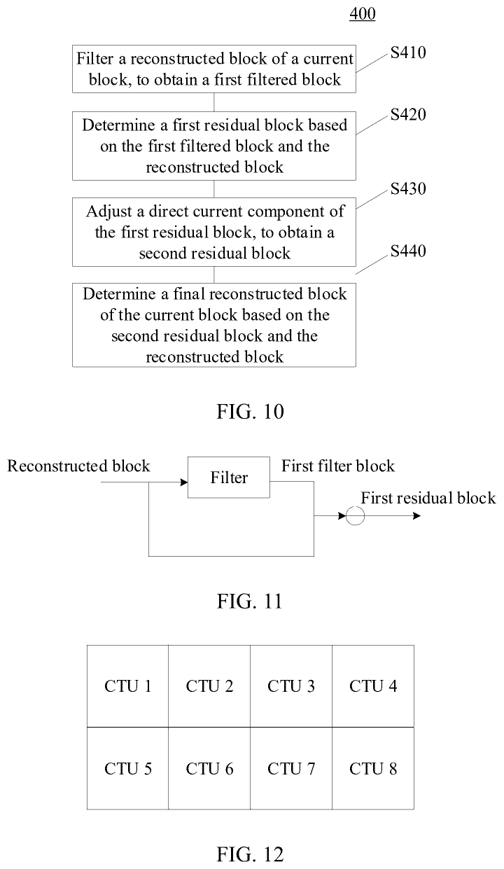

With reference to FIG. 10, the following describes a decoding method provided in this application.

FIG. 10 is a schematic flowchart of a decoding method 400 according to this application. It should be understood that the decoding method 400 may be executed by a decoder. For example, the decoding method 400 may be executed by the video decoder 122 shown in FIG. 1 or the video decoder 300 shown in FIG. 4. For ease of description, the following uses a decoder as an example.

As shown in FIG. 10, the decoding method 400 may include the following steps S410 to S440.

S410: a reconstructed block of a current block is filtered, to obtain a first filtered block.

Exemplarily, the decoder performs in-loop filtering on the reconstructed block of the current block, to obtain the first filtered block.

Exemplarily, the current block may be a CTU, a block larger than the CTU, or a block smaller than the CTU.

Exemplarily, the current block may be an image block, a sub-image, a rectangular area, or a slice.

S420: a first residual block is determined based on the first filtered block and the reconstructed block.

Exemplarily, the decoder subtracts the reconstructed block from the first filtered block, to obtain the first residual block.

S430: a direct current component of the first residual block is adjusted, to obtain a second residual block.

Exemplarily, the decoder adjusts the direct current component of the first residual block to 0 or approximately 0, to obtain the second residual block.

Exemplarily, the direct current component of the first residual block includes an average value of sample residual values in the first residual block.

In embodiments of this application, the decoder adjusts the direct current component of the first residual block, to prevent the sample residual values in the first residual block from being independently increased or decreased, thereby avoiding a limitation on adjustment of the first residual block performed by the decoder, and improving universality of the decoding method provided in this application.

S440: a final reconstructed block of the current block is determined based on the second residual block and the reconstructed block.

In embodiments, a first residual block is determined based on a reconstructed block of a current block and a first filtered block obtained by filtering the reconstructed block of the current block. Therefore, a direct current component of the first residual block is adjusted, to obtain a second residual block, and a final reconstructed block of the current block is determined based on the second residual block and the reconstructed block. In other words, the final reconstructed block is determined based on a corrected first filtered block, thereby improving decoding performance of a decoder.

In addition, the solutions provided in this application are implemented by an NNVC-based baseline filtering tool LC NNLF based on all frame types (including I-frame, P-frame, and B-frame), and performance of the solutions is tested. A common sequence specified by the joint video experts team (JVET) is tested under a random access configuration, a low delay B (Low Delay B) configuration, and an all intra configuration. A comparison anchor is an LC NNLF, and test results of a part of the sequence are shown in Table 1, Table 2, and Table 3. A BD-rate in the tables may be used to measure algorithm performance and includes changes in a peak signal-to-noise ratio (PSNR) and a mean structural similarity index measure (MSIM). A negative value of the BD-rate indicates performance improvement, and a larger absolute value of the BD-rate indicates higher performance improvement. In the tables, EncT represents a change in encoding complexity, DecT represents a change in complexity, Y represents luma, Cb (U) represents blue chroma, and Cr (V) represents red chroma.

TABLE 1

| | Y-PSNR | U-PSNR | V-PSNR | Y-MSIM | U-MSIM | V-PMSIM | EncT | DecT |
|---|---|---|---|---|---|---|---|---|
| B | −0.06% | −0.71% | −0.74% | 0.07% | −0.17% | −0.52% | 98% | 96% |
| C | −0.06% | −0.99% | −0.49% | −0.01% | −0.13% | −0.16% | 100% | 99% |
| D | −0.03% | −0.74% | −0.77% | −0.03% | 0.03% | −0.48% | 102% | 101% |
| F | −0.03% | −0.47% | −0.26% | −0.02% | −0.02% | 0.23% | 96% | 94% |

As shown in Table 1, under the random access configuration, an optimization method of residual adjustment is introduced, so that encoding and decoding performance, especially in a chroma component, can be improved based on filtering (without substantially increasing encoding and decoding complexity).

TABLE 2

| | Y-PSNR | U-PSNR | V-PSNR | Y-MSIM | U-MSIM | V-PMSIM | EncT | DecT |
|---|---|---|---|---|---|---|---|---|
| C | −0.01% | −1.39% | −0.48% | −0.07% | −0.13% | −0.16% | 99% | 99% |
| D | −0.03% | −0.64% | −1.39% | −0.41% | 1.38% | 0.95% | 99% | 99% |

As shown in Table 2, under the low delay B configuration, an optimization method of residual adjustment is introduced, so that encoding and decoding performance, especially in a chroma component, can be improved based on filtering (without substantially increasing encoding and decoding complexity).

TABLE 3

| | Y-PSNR | U-PSNR | V-PSNR | Y-MSIM | U-MSIM | V-PMSIM | EncT | DecT |
|---|---|---|---|---|---|---|---|---|
| C | −0.01% | −0.31% | −0.27% | 0.00% | −0.01% | 0.00% | 103% | 103% |
| E | −0.02% | −0.20% | −0.06% | 0.00% | −0.09% | −0.06% | 105% | 108% |
| D | 0.00% | −0.30% | −0.85% | 0.05% | −0.09% | −0.67% | 96% | 102% |

As shown in Table 3, under the all intra configuration, an optimization method of residual adjustment is introduced, so that encoding and decoding performance, especially in a chroma component, can be improved based on filtering (without substantially increasing encoding and decoding complexity).

In some embodiments, S420 may include:
decoding a bitstream to determine a first identifier; and
in a case that the first identifier indicates adjusting a filtered image corresponding to a current image to which the current block belongs, determining the first residual block based on the first filtered block and the reconstructed block.

Exemplarily, the first identifier is an identifier at an image level.

Exemplarily, the filtered image corresponding to the current image to which the current block belongs is a filtered image obtained by performing filtering (for example, in-loop filtering) on a reconstructed image of the current image.

Exemplarily, the first identifier indicating adjusting the filtered image corresponding to the current image to which the current block belongs may be understood as or equivalent to: the first identifier indicates adjusting a filtered image to which the first filtered block belongs, or the first identifier indicates allowing the current image to which the current block belongs to use a residual offset adjustment (ROA) unit or module.

Exemplarily, in a case that a value of the first identifier is 0 or 1, the first identifier indicates adjusting the filtered image corresponding to the current image to which the current block belongs.

Exemplarily, in a case that the first identifier is activated or enabled (enable), the first identifier indicates adjusting the filtered image corresponding to the current image to which the current block belongs.

Exemplarily, the decoder may determine the first identifier by decoding image header information in the bitstream. In other words, the first identifier may be carried in the image header information in the bitstream.

Exemplarily, the first identifier may be an identifier for a first component of the current block. In other words, the first identifier may indicate adjusting a filtered image that corresponds to the current image to which the current block belongs and corresponds to the first component. The first component may be a color component. For example, the first component may be a luma component or a chroma component. For another example, the first component may be a luma component, a blue chroma component, or a red chroma component.

Exemplarily, the first identifier may be an identifier for a first channel of the current block. In other words, the first identifier may indicate adjusting a filtered image that corresponds to the current image to which the current block belongs and corresponds to the first channel. The first channel may be a color channel. For example, the first channel may be a luma channel or a chroma channel.

In some embodiments, the decoder decodes the bitstream, to determine a second identifier; and in a case that the second identifier indicates adjusting a filtered image corresponding to an image in an image sequence to which the current image belongs, the decoder decodes the bitstream to determine the first identifier.

Exemplarily, the second identifier is an identifier at an image sequence level.

Exemplarily, the filtered image corresponding to the image in the image sequence to which the current image belongs is a filtered image obtained by performing filtering (for example, in-loop filtering) on a reconstructed image of the image in the image sequence to which the current image belongs.

Exemplarily, the second identifier indicating adjusting the filtered image corresponding to the image in the image sequence to which the current image belongs may be understood as or equivalent to: the second identifier indicates adjusting a filtered image in a filtered image sequence to which the first filtered block belongs, or the first identifier indicates allowing the image sequence to which the current image belongs to use a residual offset adjustment (ROA) unit or module.

Exemplarily, in a case that a value of the second identifier is 0 or 1, the filtered image corresponding to the image in the image sequence to which the current image belongs is adjusted.

Exemplarily, in a case that the second identifier is activated or enabled (enable), the filtered image corresponding to the image in the image sequence to which the current image belongs is adjusted.

Exemplarily, the decoder may determine the second identifier by decoding sequence header information in the bitstream. In other words, the second identifier may be carried in the sequence header information in the bitstream.

Exemplarily, the decoder decodes the bitstream to determine a second identifier; and in a case that the second identifier indicates adjusting a filtered image corresponding to an image in an image sequence to which the current image belongs, the decoder decodes the bitstream to determine the first identifier. In a case that the first identifier indicates adjusting a filtered image corresponding to a current image to which the current block belongs, the decoder determines the first residual block based on the first filtered block and the reconstructed block.

The following describes the first identifier and the second identifier with reference to Table 4 and Table 5.

TABLE 4

| | Descriptor |
|---|---|
| sequence_header( ) { | |
| ... | |
| roa_enable_flag | u(1) |
| ... | |
| } | |

As shown in Table 4, sequence_header represents sequence header information, which includes a roa_enable_flag (that is, the second identifier), and roa_enable_flag is an identifier at a sequence level.

TABLE 5

| | Descriptor |
|---|---|
| picture_header( ) { | |
| ... | ... |
| if(roa_enable_flag) { | |
| for (Idx=0; Idx<N; Idx++) { | |
| picture_roa_enable_flag[Idx] | u(1) |
| } | |
| } | |
| ... | |
| } | |

As shown in Table 5, picture_header represents image header information, which may include picture_roa_enable_flag[Idx] (that is, the first identifier), and picture_roa_enable_flag[Idx] is an identifier at an image level.

When decoding a bitstream, the decoder may first parse sequence header information in the bitstream, to obtain roa_enable_flag. When roa_enable_flag is 1, the decoder parses image header information, to obtain picture_roa_enable_flag[N]. Herein, N may be 3, indicating three components, that is, Y, Cb, and Cr, and N may be 2, indicating two types of channels, that is, luma and chroma. When picture_roa_enable_flag[N] is 1, it indicates that a filtered image for a component N is adjusted; or when picture_roa_enable_flag[N] is 0, it indicates that a filtered image for a component N is not adjusted.

In some embodiments, S430 may include:
determining an adjustment value based on at least one sample residual value in the first residual block; and
subtracting the adjustment value from a sample residual value in the at least one sample residual value, to obtain the second residual block.

Exemplarily, the decoder performs an arithmetic operation on the at least one sample residual value, to obtain the adjustment value; and then subtracts the adjustment value from each of the at least one sample residual value, to obtain the second residual block. Certainly, in another alternative embodiment, the decoder may adjust a sample residual value in the at least one sample residual value based on the adjustment value and in another manner. This is not specifically limited in this application.

In some embodiments, the at least one sample residual value includes all sample residual values in the first residual block.

Exemplarily, the decoder determines the adjustment value based on all the sample residual values in the first residual block and subtracts the adjustment value from each sample residual value in the first residual block, to obtain the second residual block.

In some embodiments, the at least one sample residual value includes a non-zero sample residual value in the first residual block.

Exemplarily, the non-zero sample residual value in the first residual block includes a sample residual whose value is not zero in the first residual block.

Exemplarily, the decoder determines the adjustment value based on all non-zero sample residual values in the first residual block and subtracts the adjustment value from each non-zero sample residual value in the first residual block, to obtain the second residual block.

In some embodiments, the at least one sample residual value includes a sample residual value in each of at least one group obtained by dividing sample residual values in the first residual block according to at least one predefined value range.

Exemplarily, the decoder may divide sample residual values in the first residual block into at least one group according to at least one predefined value range and then determine a sample residual value in any one of the at least one group as the at least one sample residual value. In other words, the decoder may determine the adjustment value based on a sample residual value in the group and subtract the adjustment value from each sample residual value in the group, to obtain the second residual block.

Certainly, a group involved in this application may also be understood as or equivalent to a term having a similar meaning, such as a set or an array. For example, the at least one sample residual value including a sample residual value in each of at least one group obtained by dividing sample residual values in the first residual block according to at least one predefined value range may be understood as or equivalent to: the at least one sample residual value includes a sample residual value in each of at least one set obtained by dividing sample residual values in the first residual block according to at least one predefined value range.

Exemplarily, the at least one predefined value range may be implemented by pre-storing a corresponding code, a table, or another form that may be used to indicate related information in the decoder, or the at least one predefined value range may be specified or defined in a standard protocol.

Exemplarily, the at least one value range may be at least one absolute value range. In this case, the decoder classifies, based on an absolute value of any sample residual value in the first residual block, the sample residual value to a group corresponding to an absolute value range to which the absolute value of the sample residual value belongs.

Exemplarily, the at least one value range may include a value range used to group negative sample residual values in the first residual block, and a value range used to group positive sample residual values in the first residual block. In this case, the decoder classifies, based on any sample residual value in the first residual block, the sample residual value to a group corresponding to an absolute value range to which the sample residual value belongs.

Exemplarily, the decoder may use a plurality of values to represent or determine the at least one value range. In other words, the at least one sample residual value includes a sample residual value in each of at least one group obtained by dividing sample residual values in the first residual block according to at least one predefined value. For example, the decoder may use N values to represent or determine N−1 value ranges. Specifically, the decoder may determine two adjacent values in the N values as one of the at least one value range.

Exemplarily, there may be a one-to-one correspondence between the at least one value range and the at least one group, or there may be many-to-one correspondence between the at least one value range and the at least one group. For example, in a case that the at least one value range is at least one absolute value range, there may be a one-to-one correspondence between the at least one value range and the at least one group. For another example, in a case that the at least one value range may include a value range used to group negative sample residual values in the first residual block and a value range used to group positive sample residual values in the first residual block, value ranges whose upper limits are equal regarding the absolute value and whose lower limits are equal regarding the absolute value among the at least one value range may correspond to a same group in the at least one group.

Exemplarily, assuming that a sample residual value in the first residual block is denoted as res, the decoder may determine an adjustment value corresponding to each group based on the following code:

if (res = 0 ) AVG_OFFSET_1 = 0;
else if (0 <res<=x1 || −x1<=res<0) compute AVG_OFFSET_2;
else if (x1<res<=x2 || −x2<=res<−x1) compute AVG_OFFSET_3;
else if (x2<res<=x3 || −x3<=res<−x2) compute AVG_OFFSET_4;
...
else if (xN<res || res < −xN) compute AVG_OFFSET_N;

Herein, {x1, x2, x3, . . . , xN} are positive integers that are within at least one absolute value range and that are used to divide the sample residual values in the first residual block into at least one group, {AVG_OFFSET_1, AVG_OFFSET_2, AVG_OFFSET_3, . . . , AVG_OFFSET_N} represents an average value of sample residual values in the first group to an average value of sample residual values in the N^{th} group.

In embodiments of this application, the decoder calculates the adjustment value in units of groups in the first residual block and adjusts sample residual values in an interval based on an adjustment value corresponding to the interval. In this way, when a difference between the sample residual values in the first residual block is relatively large, sample distortion caused by excessive adjustment of some sample residual values can be avoided, thereby improving quality of a final reconstructed image and improving decoding performance of the decoder.

In some embodiments, S430 may include:
determining a first residual image based on the first residual block and at least one residual block, where the at least one residual block includes a residual block determined based on a filtered block obtained by filtering a first block and a reconstructed block of the first block, and the first block is an image block in a current image to which the current block belongs; determining an adjustment value based on at least one sample residual value in a sliding window in the first residual image; and subtracting the adjustment value from a sample residual value in the at least one sample residual value, to obtain a residual image that includes the second residual block.

Exemplarily, the at least one residual block includes a residual block obtained by subtracting a reconstructed block of a first block from a filtered block obtained by filtering the first block. The at least one residual block includes the first residual block.

Exemplarily, a size of the sliding window is a non-integer multiple or an integer multiple of a size of the current block.

Exemplarily, the sliding window is a window of a predefined size. The window of the predefined size may be implemented by pre-storing a corresponding code, a table, or another form that may be used to indicate related information in the decoder, or the window of the predefined size may be specified or defined in a standard protocol.

In embodiments of this application, the decoder adjusts a sample residual value based on the sliding window in the first residual image. Compared with a solution of adjusting a sample residual value on a per-block basis, a sample residual value can be smoothly adjusted between image blocks according to the solution of this application, thereby avoiding sample distortion at a boundary of an image block when a sample residual value is adjusted on a per-block basis, improving quality of a final reconstructed image, and improving decoding performance of the decoder.

In some embodiments of this application, the at least one sample residual value includes all sample residual values within the sliding window.

Exemplarily, the decoder determines the adjustment value based on all the sample residual values in the sliding window and subtracts the adjustment value from each sample residual value in the sliding window, to obtain the second residual block.

In some embodiments of this application, the at least one sample residual value includes a non-zero sample residual value in the sliding window.

Exemplarily, the non-zero sample residual value in the sliding window includes a sample residual whose value is not zero in the sliding window.

Exemplarily, the decoder determines the adjustment value based on all non-zero sample residual values in the sliding window and subtracts the adjustment value from each non-zero sample residual value in the sliding window, to obtain the second residual block.

In some embodiments of this application, the at least one sample residual value includes a sample residual value in each of at least one group obtained by dividing sample residual values in the sliding window according to at least one predefined value range.

Exemplarily, the decoder may divide sample residual values in the sliding window into at least one group according to at least one predefined value range and then determine a sample residual value in any of the at least one group as the at least one sample residual. In other words, the decoder may determine the adjustment value based on a sample residual value in the group and subtract the adjustment value from each sample residual value in the group, to obtain the second residual block.

Certainly, a group involved in this application may also be understood as or equivalent to a term having a similar meaning, such as a set or an array. For example, the at least one sample residual value including a sample residual value in each of at least one group obtained by dividing sample residual values in the sliding window according to at least one predefined value range may be understood as or equivalent to: the at least one sample residual value includes a sample residual value in each of at least one set obtained by dividing sample residual values in the sliding window according to at least one predefined value range.

Exemplarily, the at least one predefined value range may be implemented by pre-storing a corresponding code, a table, or another form that may be used to indicate related information in the decoder, or the at least one predefined value range may be specified or defined in a standard protocol.

Exemplarily, the at least one value range may be at least one absolute value range. In this case, the decoder classifies, based on an absolute value of any sample residual value in the sliding window, the sample residual value to a group corresponding to an absolute value range to which the absolute value of the sample residual value belongs.

Exemplarily, the at least one value range may include a value range used to group negative sample residual values in the sliding window, and a value range used to group positive sample residual values in the sliding window. In this case, the decoder classifies, based on any sample residual value in the sliding window, the sample residual value to a group corresponding to an absolute value range to which the sample residual value belongs.

Exemplarily, the decoder may use a plurality of values to represent or determine the at least one value range. In other words, the at least one sample residual value includes a sample residual value in each of at least one group obtained by dividing sample residual values in the sliding window according to at least one predefined value. For example, the decoder may use N values to represent or determine N−1 value ranges. Specifically, the decoder may determine two adjacent values in the N values as one of the at least one value range.

Exemplarily, there may be a one-to-one correspondence between the at least one value range and the at least one group, or there may be a many-to-one correspondence between the at least one value range and the at least one group. For example, in a case that the at least one value range is at least one absolute value range, there may be a one-to-one correspondence between the at least one value range and the at least one group. For another example, in a case that the at least one value range may include a value range used to group negative sample residual values in the sliding window and a value range used to group positive sample residual values in the sliding window, value ranges whose upper limits are equal regarding the absolute value and whose lower limits are equal regarding the absolute value in the at least one value range may correspond to a same group in the at least one group.

Exemplarily, assuming that a sample residual value in the sliding window is denoted as res, the decoder may determine an adjustment value corresponding to each group based on the following code:

if (res = 0 ) AVG_OFFSET_1 = 0;
else if (0 <res<=x1 || −x1<=res<0) compute AVG_OFFSET_2;
else if (x1<res<=x2 || −x2<=res<−x1) compute AVG_OFFSET_3;
else if (x2<res<=x3 || −x3<=res<−x2) compute AVG_OFFSET_4;
...
else if (xN<res || res < −xN) compute AVG_OFFSET_N;

Herein, {x1, x2, x3, . . . , xN} are positive integers that are within at least one absolute value range and that are used to divide the sample residual values in the sliding window into at least one group, {AVG_OFFSET_1, AVG_OFFSET_2, AVG_OFFSET_3, . . . , AVG_OFFSET_N} represents an average value of sample residual values in the first group to an average value of sample residual values in the N^{th} group.

In some embodiments, an average value of the at least one sample residual value or a value obtained by performing a rounding operation on the average value of the at least one sample residual value is determined as the adjustment value.

Exemplarily, in a case that the average value of the at least one sample residual value is an integer, the decoder determines the average value of the at least one sample residual value as the adjustment value.

Exemplarily, in a case that the average value of the at least one sample residual value is not an integer, the decoder determines a value obtained by performing a rounding operation on the average value of the at least one sample residual value as the adjustment value. For example, the decoder determines a value obtained by performing a rounding-up operation on the average value of the at least one sample residual value as the adjustment value. For another example, the decoder determines a value obtained by performing a rounding-down operation on the average value of the at least one sample residual value as the adjustment value.

In some embodiments, the adjustment value is determined based on the average value of the at least one sample residual value and a preset first value range.

Exemplarily, the decoder determines whether to determine the average value as the adjustment value by comparing the average value of the at least one sample residual value with the preset first value range. For example, in a case that the average value is within the first value range, the decoder determines the average value as the adjustment value. In a case that the average value is beyond the first value range, the decoder may determine an upper limit or a lower limit of the first value range as the adjustment value.

In some embodiments, in a case that the average value is within the first value range, the average value or a value obtained by performing a rounding operation on the average value is determined as the adjustment value. In a case that the average value is greater than an upper limit of the first value range, the upper limit is determined as the adjustment value. In a case that the average value is less than a lower limit of the first value range, the lower limit is determined as the adjustment value.

Certainly, in another alternative embodiment, in a case that the average value is beyond the first value range, the decoder may determine the adjustment value in another manner. This application sets no specific limitation thereto. For example, in a case that the average value is beyond the first value range, the decoder may determine a predefined value as the adjustment value.

In some embodiments, S410 may include:
filtering the reconstructed block by using any one of the following filters, to obtain the first filtered block:
a deblocking filter, a sample adaptive offset filter, an adaptive loop filter, or a neural network based loop filter.

Exemplarily, the decoder filters the reconstructed block of the current block by using a neural network based loop filter, to obtain a first filtered block; determines a first residual block based on the first filtered block and the reconstructed block; adjusts a direct current component of the first residual block, to obtain a second residual block; and determines a final reconstructed block of the current block based on the second residual block and the reconstructed block.

The following exemplarily describes the decoding method provided in this application with reference to Embodiment 1.

### Embodiment 1

In this embodiment, an in-loop filtering unit acts on a decoder, that is, the decoder first filters a reconstructed block of a current block by using a neural network based loop filter, to output a first filtered block. Then, the decoder subtracts the reconstructed block from the first filtered block, to obtain a first residual block, and corrects the first residual block to obtain a second reference block. Then, the decoder adds the second residual block and the reconstructed block, to obtain a final reconstructed block. In this way, filtering performance of the neural network based loop filter is optimized by correcting the first residual block, thereby improving decoding performance of the decoder.

A specific procedure of the decoder is as follows.

a) When processing of the decoder is executed by the in-loop filtering unit, the in-loop filtering unit performs processing according to a specified sequence of filters. When processing is executed by an ROA unit, it is first determined, based on an identifier at a sequence level (that is, the second identifier mentioned above, which is denoted as roa_enable_flag) obtained by decoding a bitstream, whether the ROA unit can be used for the current sequence. In a case that roa_enable_flag is “0”, the ROA unit is not used for the current sequence. In a case that roa_enable_flag is “1”, the decoder determines, based on an identifier at an image level (that is, the first identifier mentioned above, which is denoted as picture_roa_enable_flag) obtained by decoding a bitstream, whether the ROA unit can be used for an image block in a current image. In a case that picture_roa_enable_flag is “0”, the ROA unit is not used for the image block in the current image. In a case that picture_roa_enable_flag is “1”, the ROA unit tries to process the image block in the current image, that is, step b) is executed.

b) For a current block in the current image, the decoder first inputs a reconstructed block of the current block into an NNLF, to output a first filtered block. Then, the decoder executes step c).

c) After obtaining the first filtered block, the decoder may subtract the reconstructed block from the first filtered block, to obtain a first residual block, and correct the first residual block to obtain a second residual block. Then, the decoder adds the second residual block and the reconstructed block, to obtain a final reconstructed block.

The following exemplarily describes a specific implementation of residual adjustment.

FIG. 11 is an example of a principle of determining a first residual block according to this application.

As shown in FIG. 11, a decoder may obtain a first residual block (res) by subtracting an input reconstructed block (rec) from a first filtered block (cnn) output by a filter.

It should be noted that the filter used to filter the reconstructed block is not specifically limited in this application. This application aims to correct the first residual block obtained by subtracting the input of the filter from the first filtered block output by the filter. Theoretically, for any filtering tool, the first residual block may be adjusted by using the solutions in this application as long as the first residual block (res) of the first filtered block (filtered) relative to the reconstructed block (rec) can be calculated. For example, the first residual block obtained by subtracting an input of a DB, an SAO, or an ALF from a first filtered block output by the DB, the SAO, or the ALF may be adjusted.

In one implementation, the decoder may directly correct a sample residual value in the first residual block at a granularity of a block.

For example, the decoder may correct a residual value on a per-block basis by traversing all residual blocks (for example, at a CTU level) of a to-be-corrected residual image, to finally obtain a corrected residual image.

For example, assuming that the to-be-corrected residual image includes a CTU 1 to a CTU 8 shown in FIG. 12, the decoder may correct a sample residual value in each of the CTU 1 to the CTU 8, that is, traversing the CTU 1 to the CTU 8 to correct a sample residual value on a per-CTU basis, to finally obtain a corrected residual image.

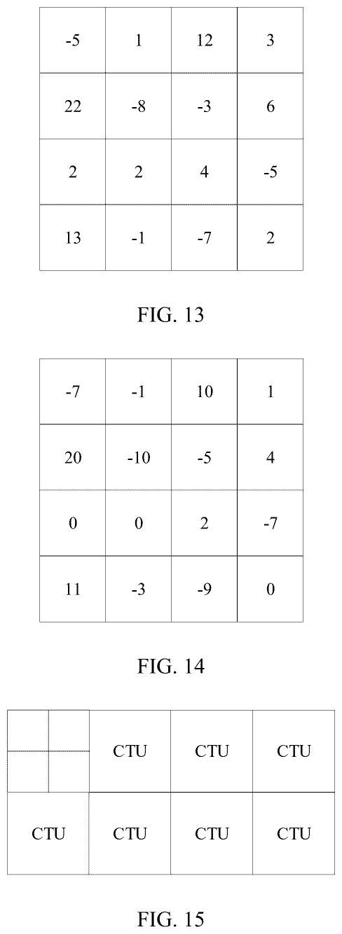

Because the first residual block is uninterpretable, the first residual block is corrected by adjusting a direct current component (DC) of the first residual block to zero in this application. For example, to adjust the direct current component (Direct Current, DC) of the first residual block to zero, an average value of sample residual values in the first residual block needs to be adjusted to zero. For example, the average value may be obtained by calculating a sum of all the sample residual values in the first residual block and calculating an average value of the sum. Then, a corrected second residual block may be obtained by subtracting the average value from each sample residual value in the first residual block, and a direct current component of the corrected second residual block is zero (or approximately zero). For example, for the first residual block shown in FIG. 13, the average value of the sample residual values in the first residual block may be calculated as 2.375, which is rounded to 2. Then, for the first residual block, the corrected second residual block shown in FIG. 14 may be obtained by subtracting the average value from each sample residual value in the first residual block.

Certainly, in another alternative embodiment, the decoder may perform residual adjustment on an image block smaller or larger than a CTU. For example, as shown in FIG. 15, 2×2 partitioning is further performed on the CTU, to obtain four sub-image blocks, and then a sample residual value in each sub-image block is corrected.

In another implementation, the decoder may correct a sample residual value in an image at a granularity of a sliding window.

For example, the decoder may correct a sample residual value within a sliding window in a to-be-corrected residual image by moving the sliding window, to finally obtain a corrected residual image. The to-be-corrected residual image may be an image obtained by subtracting a reconstructed image of a current image from a filtered image of the current image.

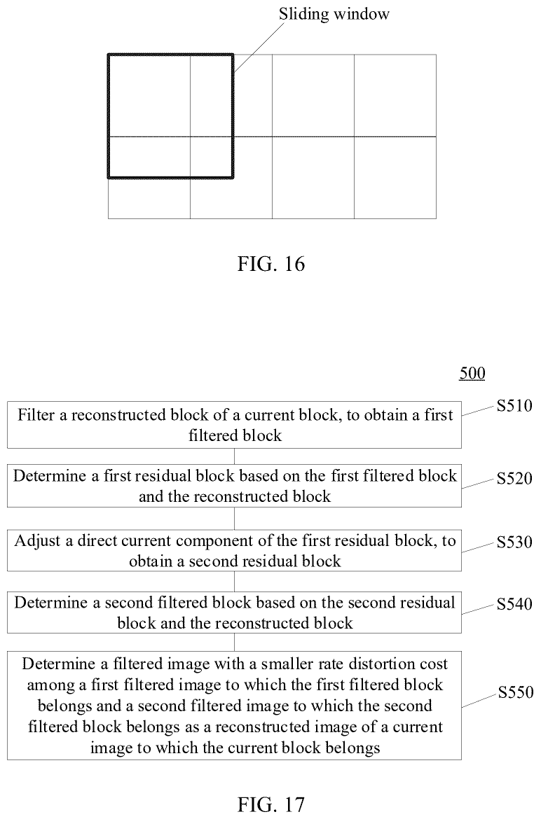

For example, assuming that the to-be-corrected residual image includes eight CTUs shown in FIG. 16 and a size of the sliding window is 1.5 CTU×1.5 CTU, the decoder may correct the sample residual value in the sliding window. That is, the decoder may correct a sample residual value in the to-be-corrected residual image by moving the sliding window according to a predefined sliding step size, to finally obtain a corrected residual image.

Certainly, regardless of whether the decoder adjusts a sample residual value at a granularity of a block or a sliding window, in another alternative embodiment, the decoder may calculate a sum of some sample residual values (for example, non-zero sample residual values) in the first residual block or the sliding window and calculate an average value of the sum, to obtain an average value of the sample residual values. In this case, the decoder adjusts the sample residual values. After calculating an average value of all sample residual values (or some sample residual values) in the first residual block or the sliding window, the decoder may even further determine whether to adjust a residual value by using the average value. For example, in a case that the average value is within a predefined value range, the average value is used to adjust a residual value; or in a case that the average value is less than a lower limit of a predefined value range, the lower limit is used to adjust a residual value; or in a case that the average value is greater than an upper limit of a predefined value range, the upper limit is used to adjust a residual value.

FIG. 17 is a schematic flowchart of an encoding method 500 according to this application.

It should be understood that the encoding method 500 may be executed by an encoder. For example, the encoding method is applied to the encoding framework 100 shown in FIG. 1. For ease of description, the following uses an encoder as an example.

As shown in FIG. 17, the encoding method 500 may include the following steps S510 to S550.

S510: a reconstructed block of a current block is filtered, to obtain a first filtered block.

S520: a first residual block is determined based on the first filtered block and the reconstructed block.

S530: a direct current component of the first residual block is adjusted, to obtain a second residual block.

S540: a second filtered block is determined based on the second residual block and the reconstructed block.

S550: a filtered image with a smaller rate distortion cost among a first filtered image to which the first filtered block belongs and a second filtered image to which the second filtered block belongs, is determined as a reconstructed image of a current image to which the current block belongs.

In some embodiments, the method 500 may further include:
encoding a first identifier,
where when a rate distortion cost of the first filtered image is less than or equal to a rate distortion cost of the second filtered image, the first identifier indicates not adjusting a filtered image corresponding to the current image to which the current block belongs; or when a rate distortion cost of the first filtered image is greater than a rate distortion cost of the second filtered image, the first identifier indicates adjusting a filtered image corresponding to the current image.

In some embodiments, the method 500 may further include:
encoding a second identifier,
where the second identifier indicates adjusting or not adjusting a filtered image corresponding to an image in an image sequence to which the current image belongs.

In some embodiments of this application, S530 may include:
determining an adjustment value based on at least one sample residual value in the first residual block; and
subtracting the adjustment value from a sample residual value in the at least one sample residual value, to obtain the second residual block.

In some embodiments of this application, the at least one sample residual value includes all sample residual values in the first residual block.

In some embodiments of this application, the at least one sample residual value includes a non-zero sample residual value in the first residual block, or the at least one sample residual value includes a sample residual value in each of at least one group obtained by dividing sample residual values in the first residual block according to at least one predefined value range.

In some embodiments of this application, S530 may include:
determining a first residual image based on the first residual block and at least one residual block,
where the at least one residual block includes a residual block determined based on a filtered block obtained by filtering a first block and a reconstructed block of the first block, and the first block is an image block in a current image to which the current block belongs;
determining an adjustment value based on at least one sample residual value in a sliding window in the first residual image; and
subtracting the adjustment value from a sample residual value in the at least one sample residual value, to obtain a residual image that includes the second residual block.

In some embodiments of this application, the at least one sample residual value includes all sample residual values within the sliding window.

In some embodiments of this application, the at least one sample residual value includes a non-zero sample residual value in the sliding window, or the at least one sample residual value includes a sample residual value in each of at least one group obtained by dividing sample residual values in the sliding window according to at least one predefined value range.

In some embodiments of this application, an average value of the at least one sample residual value or a value obtained by performing a rounding operation on the average value of the at least one sample residual value is determined as the adjustment value.

In some embodiments of this application, the adjustment value is determined based on the average value of the at least one sample residual value and a preset first value range.

In some embodiments of this application, in a case that the average value is within the first value range, the average value or a value obtained by performing a rounding operation on the average value is determined as the adjustment value; or in a case that the average value is greater than an upper limit of the first value range, the upper limit is determined as the adjustment value; or in a case that the average value is less than a lower limit of the first value range, the lower limit is determined as the adjustment value.

In some embodiments of this application, S510 may include:
filtering the reconstructed block by using any one of the following filters, to obtain the first filtered block:
a deblocking filter, a sample adaptive offset filter, an adaptive loop filter, or a neural network based loop filter.

It should be understood that the encoding method may be understood as an inverse process of the decoding method. Therefore, for a specific solution of the encoding method 500, reference may be made to related content of the decoding method 400. For ease of description, details are not described in this application.

The following exemplarily describes the encoding method provided in this application with reference to Embodiment 2.

### Embodiment 2

In this embodiment, an in-loop filtering unit acts on an encoder, that is, the encoder first filters a reconstructed block of a current block by using a neural network based loop filter, to output a first filtered block. Then, the encoder subtracts the reconstructed block from the first filtered block, to obtain a first residual block, and corrects the first residual block to obtain a second residual block. Then, the encoder adds the second residual block and the reconstructed block, to obtain a final reconstructed block. In this way, filtering performance of the neural network based loop filter is optimized by correcting the first residual block, thereby improving decoding performance of the encoder.

A specific procedure of the encoder is as follows.

a) When processing of the encoder is executed by the in-loop filtering unit, the in-loop filtering unit performs processing according to a specified sequence of filters. When processing is executed by an ROA unit, it is first determined, based on an identifier at a sequence level (that is, the second identifier mentioned above, which is denoted as roa_enable_flag), whether the ROA unit can be used for the current sequence. In a case that roa_enable_flag is “0”, the ROA unit is not used for the current sequence. In a case that roa_enable_flag is “1”, the ROA unit tries to process the current sequence, that is, step b) is executed.

b) For a current block in a current image, the encoder first inputs a reconstructed block of the current block into an NNLF, to output a first filtered block. Then, the encoder executes step c).

c) After obtaining the first filtered block, the encoder may subtract the reconstructed block from the first filtered block, to obtain a first residual block, and correct the first residual block to obtain a second residual block. Then, the encoder adds the second residual block and the reconstructed block, to determine a second filtered block. Then, the encoder executes step d).

d) The encoder compares a first filtered image to which the first filtered block belongs with an original image of the current image, to calculate a rate distortion cost (denoted as C_{NNLF}); and compares a second filtered image to which the second filtered block belongs with the original image of the current image, to calculate a rate distortion cost (denoted as C_{ROA}). Then, the encoder determines a reconstructed image of the current image by comparing C_{ROA} with C_{NNLF}.

For example, in a case that C_{ROA}<C_{NNLF}, the encoder uses the second filtered image output by the ROA unit as a final reconstructed image; or in a case that C_{ROA}≥C_{NNLF}, the encoder uses the first filtered image output by the NNLF as a final reconstructed image. Then, the encoder executes step e).

e) The encoder encodes an identifier at an image level (that is, the first identifier mentioned above, which is denoted as picture_roa_enable_flag) of the current image into a bitstream, and executes step f).

f) In a case that processing on the current image is completed, the encoder loads a next frame for processing and executes step b).

The following exemplarily describes a specific implementation of residual adjustment.

FIG. 11 is an example of a first residual block according to this application.

As shown in FIG. 11, an encoder may obtain a first residual block (res) by subtracting an input reconstructed block (rec) from a first filtered block (cnn) output by a filter.

It should be noted that, the filter used to filter the reconstructed block is not specifically limited in this application. This application aims to correct the first residual block obtained by subtracting the input of the filter from the first filtered block output by the filter. Theoretically, for any filtering tool, the first residual block may be adjusted by using the solutions in this application as long as the first residual block (res) of the first filtered block (filtered) relative to the reconstructed block (rec) can be calculated. For example, the first residual block obtained by subtracting an input of a DB, an SAO, or an ALF from a first filtered block output by the DB, the SAO, or the ALF may be adjusted.

In one implementation, the encoder may directly correct a sample residual value in the first residual block at a granularity of a block.

For example, the encoder may correct a residual value on a per-block basis by traversing all residual blocks (for example, at a CTU level) of a to-be-corrected residual image, to finally obtain a corrected residual image.

For example, assuming that the to-be-corrected residual image includes a CTU 1 to a CTU 8 shown in FIG. 12, the encoder may correct a sample residual value in each of the CTU 1 to the CTU 8, that is, traversing the CTU 1 to the CTU 8 to correct a sample residual value on a per-CTU basis, to finally obtain a corrected residual image.

Because the first residual block is uninterpretable, the first residual block is corrected by adjusting a direct current component (DC) of the first residual block to zero in this application. For example, to adjust the direct current component (Direct Current, DC) of the first residual block to zero, an average value of sample residual values in the first residual block needs to be adjusted to zero. For example, the average value may be obtained by calculating a sum of all the sample residual values in the first residual block and calculating an average of the sum. Then, a corrected second residual block may be obtained by subtracting the average value from each sample residual value in the first residual block, and a direct current component of the corrected second residual block is zero (or approximately zero). For example, for the first residual block shown in FIG. 13, the average value of the sample residual values in the first residual block may be calculated as 2.375, which is rounded to 2. Then, for the first residual block, the corrected second residual block shown in FIG. 14 may be obtained by subtracting the average value from each sample residual value in the first residual block.

Certainly, in another alternative embodiment, the encoder may perform residual adjustment on an image block smaller or larger than a CTU. For example, as shown in FIG. 15, 2×2 partitioning is further performed on the CTU, to obtain four sub-image blocks, and then a sample residual value in each sub-image block is corrected.

In another implementation, the encoder may correct a sample residual value in an image at a granularity of a sliding window.

For example, the encoder may correct a sample residual value within a sliding window in a to-be-corrected residual image by moving the sliding window, to finally obtain a corrected residual image. The to-be-corrected residual image may be an image obtained by subtracting a reconstructed image of a current image from a filtered image of the current image.

For example, assuming that the to-be-corrected residual image includes eight CTUs shown in FIG. 16, and a size of the sliding window is 1.5 CTU×1.5 CTU, the encoder may correct the sample residual value in the sliding window. That is, the encoder may correct a sample residual value in the to-be-corrected residual image by moving the sliding window according to a predefined sliding step size, to finally obtain a corrected residual image.

Certainly, regardless of whether the encoder adjusts a sample residual value at a granularity of a block or a sliding window, in another alternative embodiment, the encoder may calculate a sum of some sample residual values (for example, non-zero sample residual values) in the first residual block or the sliding window and calculate an average value of the sum, to obtain an average value of the sample residual values. In this case, the encoder adjusts the sample residual values. After calculating an average value of all sample residual values (or some sample residual values) in the first residual block or the sliding window, the encoder may even further determine whether to adjust a residual value by using the average value. For example, in a case that the average value is within a predefined value range, the average value is used to adjust a residual value; or in a case that the average value is less than a lower limit of a predefined value range, the lower limit is used to adjust a residual value; or in a case that the average value is greater than an upper limit of a predefined value range, the upper limit is used to adjust a residual value.

The foregoing describes in detail the preferred implementations of this application with reference to the accompanying drawings. However, this application is not limited to specific details in the foregoing implementations. Within the scope of the technical concepts of this application, various simple variations may be implemented to the technical solutions in this application, and these simple variations are all within the protection scope of this application. For example, specific technical features described in the foregoing specific implementations may be combined in any suitable manner in the case of no conflict. To avoid unnecessary repetition, various possible combination manners are not described in this application. For another example, any combination may alternatively be performed between different implementations of this application, provided that the combination is not contrary to the idea of this application, and the combination shall also be considered as the content disclosed in this application. It should be further understood that, in the method embodiments of this application, sequence numbers of the foregoing processes do not mean execution sequences. The execution sequences of the processes shall be determined based on functions and internal logic of the processes and shall not be construed as any limitation on the implementation processes of embodiments of this application. In addition, in embodiments of this application, the term “and/or” is merely used to describe an association relationship between associated objects, indicating that there may be three relationships. Specifically, A and/or B may represent three cases: only A exists, both A and B exist, and only B exists. In addition, the character “/” in the specification generally indicates an “or” relationship between the associated objects.

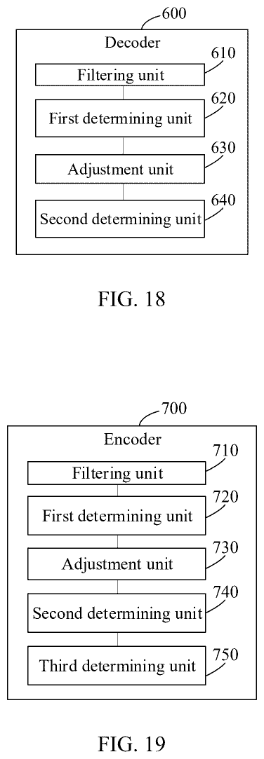

The foregoing describes in detail the method embodiments of this application. With reference to FIG. 18 to FIG. 20, the following describes in detail the apparatus embodiments of this application.

FIG. 18 is a schematic block diagram of a decoder 600 according to an embodiment of this application.

As shown in FIG. 18, the decoder 600 may include:
a filtering unit 610, configured to filter a reconstructed block of a current block, to obtain a first filtered block;
a first determining unit 620, configured to determine a first residual block based on the first filtered block and the reconstructed block;
an adjustment unit 630, configured to adjust a direct current component of the first residual block, to obtain a second residual block; and
a second determining unit 640, configured to determine a final reconstructed block of the current block based on the second residual block and the reconstructed block.

In some embodiments of this application, the first determining unit 620 is specifically configured to:
decode a bitstream to determine a first identifier; and
in a case that the first identifier indicates adjusting a filtered image corresponding to a current image to which the current block belongs, determine the first residual block based on the first filtered block and the reconstructed block.

In some embodiments of this application, the first determining unit 620 is specifically configured to:
decode the bitstream, to determine a second identifier; and
in a case that the second identifier indicates adjusting a filtered image corresponding to an image in an image sequence to which the current image belongs, decode the bitstream, to determine the first identifier.

In some embodiments of this application, the adjustment unit 630 is specifically configured to:
determine an adjustment value based on at least one sample residual value in the first residual block; and
subtract the adjustment value from a sample residual value in the at least one sample residual value, to obtain the second residual block.

In some embodiments of this application, the at least one sample residual value includes all sample residual values in the first residual block.

In some embodiments of this application, the at least one sample residual value includes a non-zero sample residual value in the first residual block, or the at least one sample residual value includes a sample residual value in each of at least one group obtained by dividing sample residual values in the first residual block according to at least one predefined value range.

In some embodiments of this application, the adjustment unit 630 is specifically configured to:
determine a first residual image based on the first residual block and at least one residual block,
where the at least one residual block includes a residual block determined based on a filtered block obtained by filtering a first block and a reconstructed block of the first block, and the first block is an image block in a current image to which the current block belongs;
determine an adjustment value based on at least one sample residual value in a sliding window in the first residual image; and
subtract the adjustment value from a sample residual value in the at least one sample residual value, to obtain a residual image that includes the second residual block.

In some embodiments of this application, the at least one sample residual value includes all sample residual values within the sliding window.

In some embodiments of this application, the at least one sample residual value includes a non-zero sample residual value in the sliding window, or the at least one sample residual value includes a sample residual value in each of at least one group obtained by dividing sample residual values in the sliding window according to at least one predefined value range.

In some embodiments of this application, the adjustment unit 630 is specifically configured to:
determine an average value of the at least one sample residual value or a value obtained by performing a rounding operation on the average value of the at least one sample residual value as the adjustment value.

In some embodiments of this application, the adjustment unit 630 is specifically configured to:
determine the adjustment value based on an average value of the at least one sample residual value and a preset first value range.

In some embodiments of this application, the adjustment unit 630 is specifically configured to:
in a case that the average value is within the first value range, determine the average value or a value obtained by performing a rounding operation on the average value as the adjustment value; or
in a case that the average value is greater than an upper limit of the first value range, determine the upper limit as the adjustment value; or
in a case that the average value is less than a lower limit of the first value range, determine the lower limit as the adjustment value.

In some embodiments of this application, the filtering unit 610 is specifically configured to:
filter the reconstructed block by using any one of the following filters, to obtain the first filtered block:
a deblocking filter, a sample adaptive offset filter, an adaptive loop filter, or a neural network based loop filter.

FIG. 19 is a schematic block diagram of an encoder 700 according to an embodiment of this application.

As shown in FIG. 19, the encoder 700 may include:
a filtering unit 710, configured to filter a reconstructed block of a current block, to obtain a first filtered block;
a first determining unit 720, configured to determine a first residual block based on the first filtered block and the reconstructed block;
an adjustment unit 730, configured to adjust a direct current component of the first residual block, to obtain a second residual block;
a second determining unit 740, configured to determine a second filtered block based on the second residual block and the reconstructed block; and
a third determining unit 750, configured to determine a filtered image with a smaller rate distortion cost among a first filtered image to which the first filtered block belongs and a second filtered image to which the second filtered block belongs, as a reconstructed image of a current image to which the current block belongs.

In some embodiments of this application, the third determining unit 750 is further configured to:
encode a first identifier,
where when a rate distortion cost of the first filtered image is less than or equal to a rate distortion cost of the second filtered image, the first identifier indicates not adjusting a filtered image corresponding to the current image to which the current block belongs; or when a rate distortion cost of the first filtered image is greater than a rate distortion cost of the second filtered image, the first identifier indicates adjusting a filtered image corresponding to the current image.

In some embodiments of this application, the third determining unit 750 is further configured to:
encode a second identifier,
where the second identifier indicates adjusting or not adjusting a filtered image corresponding to an image in an image sequence to which the current image belongs.

In some embodiments of this application, the adjustment unit 730 is specifically configured to:
determine an adjustment value based on at least one sample residual value in the first residual block; and
subtract the adjustment value from a sample residual value in the at least one sample residual value, to obtain the second residual block.

In some embodiments of this application, the at least one sample residual value includes all sample residual values in the first residual block.

In some embodiments of this application, the at least one sample residual value includes a non-zero sample residual value in the first residual block, or the at least one sample residual value includes a sample residual value in each of at least one group obtained by dividing sample residual values in the first residual block according to at least one predefined value range.

In some embodiments of this application, the adjustment unit 730 is specifically configured to:
determine a first residual image based on the first residual block and at least one residual block,
where the at least one residual block includes a residual block determined based on a filtered block obtained by filtering a first block and a reconstructed block of the first block, and the first block is an image block in a current image to which the current block belongs;
determine an adjustment value based on at least one sample residual value in a sliding window in the first residual image; and
subtract the adjustment value from a sample residual value in the at least one sample residual value, to obtain a residual image that includes the second residual block.

In some embodiments of this application, the at least one sample residual value includes all sample residual values within the sliding window.

In some embodiments of this application, the at least one sample residual value includes a non-zero sample residual value in the sliding window, or the at least one sample residual value includes a sample residual value in each of at least one group obtained by dividing sample residual values in the sliding window according to at least one predefined value range.

In some embodiments of this application, the adjustment unit 730 is specifically configured to:
determine an average value of the at least one sample residual value or a value obtained by performing a rounding operation on the average value of the at least one sample residual value as the adjustment value.

In some embodiments of this application, the adjustment unit 730 is specifically configured to:
determine the adjustment value based on an average value of the at least one sample residual value and a preset first value range.

In some embodiments of this application, the adjustment unit 730 is specifically configured to:
in a case that the average value is within the first value range, determine the average value or a value obtained by performing a rounding operation on the average value as the adjustment value; or
in a case that the average value is greater than an upper limit of the first value range, determine the upper limit as the adjustment value; or
in a case that the average value is less than a lower limit of the first value range, determine the lower limit as the adjustment value.

In some embodiments of this application, the filtering unit 710 is specifically configured to:
filter the reconstructed block by using any one of the following filters, to obtain the first filtered block:
a deblocking filter, a sample adaptive offset filter, an adaptive loop filter, or a neural network based loop filter.

It should be understood that the apparatus embodiments may correspond to the method embodiments. For similar descriptions, reference may be made to the method embodiments. To avoid repetition, details are not described herein again. Specifically, the decoder 600 shown in FIG. 18 may correspond to a corresponding body that executes the decoding method 400 in embodiments of this application, and the foregoing and other operations and/or functions of the units in the decoder 600 are respectively used to implement a corresponding procedure in the methods such as the decoding method 400. The encoder 700 shown in FIG. 19 may correspond to a corresponding body that executes the encoding method 500 in embodiments of this application, that is, the foregoing and other operations and/or functions of the units in the encoder 700 are respectively used to implement a corresponding procedure in the methods such as the encoding method 500.

It should be further understood that units in the decoder 600 or the encoder 700 in embodiments of this application are divided based on logical functions. In actual application, functions of one unit may be implemented by a plurality of units, or functions of a plurality of units are implemented by one unit, or even these functions may be implemented by one or more other units. For example, some or all of the units in the decoder 600 or the encoder 700 are combined into one or more other units. For another example, a unit or some units in the decoder 600 or the encoder 700 may be further split into a plurality of units that are functionally smaller, which may implement the same operations without affecting implementation of the technical effects of embodiments of this application. For another example, the decoder 600 or the encoder 700 may also include another unit. In actual application, these functions may also be implemented by the another unit and may be implemented by a plurality of units.

According to another embodiment of this application, a computer program (including program code) that can execute steps involved in a corresponding method may be run on a general-purpose computing device that includes a processing element such as a central processing unit (CPU), a random access memory (RAM), a read-only memory (ROM), and a storage element, to construct the decoder 600 or the encoder 700 in embodiments of this application and implement the encoding method or the decoding method in embodiments of this application. A computer program may be recorded in, for example, a computer-readable storage medium, and is installed in an electronic device by using the computer-readable storage medium, to implement a corresponding method in embodiments of this application. In other words, the foregoing units may be implemented in a hardware form, may be implemented in an instruction in a software form, or may be implemented in a combination of software and hardware. Specifically, the steps of the method embodiments in this application may be completed by using an integrated logic circuit of hardware in the processor and/or an instruction in a form of software. The steps of the method disclosed with reference to embodiments of this application may be directly executed by the hardware decoding processor or may be executed by using a combination of hardware and software in the decoding processor. Optionally, the software may be located in a mature storage medium in the art, such as a random access memory, a flash memory, a read-only memory, a programmable read-only memory, an electrically erasable programmable memory, and a register. The storage medium is located in a memory. The processor reads information from the memory and performs the steps in the foregoing method embodiments in combination with the hardware in the processor.

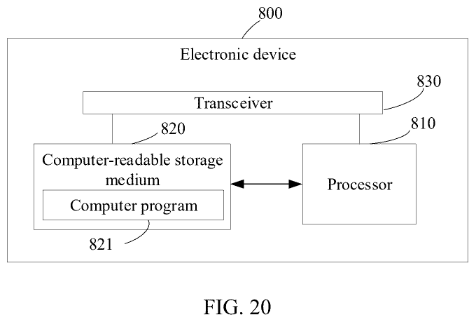

FIG. 20 is a schematic structural diagram of an electronic device 800 according to this application.

As shown in FIG. 20, the electronic device 800 at least includes a processor 810 and a computer-readable storage medium 820. The processor 810 and the computer-readable storage medium 820 may be connected by using a bus or in another manner. The computer-readable storage medium 820 is configured to store a computer program 821. The computer program 821 includes a computer instruction. The processor 810 is configured to execute the computer instruction stored in the computer-readable storage medium 820. The processor 810 is a computing core and a control core of the electronic device 800. The processor 810 is adapted to implement one or more computer instructions and is specifically adapted to load and execute one or more computer instructions, to implement a corresponding method, procedure, or function.

Exemplarily, the processor 810 may also be referred to as a central processing unit (CPU). The processor 810 may include but is not limited to a general-purpose processor, a digital signal processor (DSP), an application-specific integrated circuit (ASIC), a field-programmable gate array (FPGA) or another programmable logic device, a transistor logic device, a discrete hardware component, or the like.

Exemplarily, the computer-readable storage medium 820 may be a high-speed RAM, or may be a non-volatile memory, for example, at least one disk memory. Optionally, the computer-readable storage medium 820 may be at least one computer-readable storage medium located far away from the processor 810. Specifically, the computer-readable storage medium 820 includes but is not limited to a volatile memory and/or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM) and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (synch link DRAM, SLDRAM), and a direct rambus random access memory (Direct Rambus RAM, DR RAM).

Exemplarily, the electronic device 800 may be an encoder or an encoding framework related to an embodiment of this application. The computer-readable storage medium 820 stores a first computer instruction. The processor 810 loads and executes the first computer instruction stored in the computer-readable storage medium 820, to implement a corresponding step in the encoding method provided in this application. In other words, the first computer instruction in the computer-readable storage medium 820 is loaded by the processor 810, and a corresponding step is executed. To avoid repetition, details are not described herein again.

Exemplarily, the electronic device 800 may be a decoder or a decoding framework related to an embodiment of this application. The computer-readable storage medium 820 stores a second computer instruction. The processor 810 loads and executes the second computer instruction stored in the computer-readable storage medium 820, to implement a corresponding step in the decoding method provided in this application. In other words, the second computer instruction in the computer-readable storage medium 820 is loaded by the processor 810, and a corresponding step is executed. To avoid repetition, details are not described herein again.

According to another aspect of this application, this application further provides a codec system, including the foregoing encoder and the foregoing decoder.

According to another aspect of this application, this application further provides a computer-readable storage medium (Memory), where the computer-readable storage medium is a memory device in an electronic device 800, and is configured to store a program and data. For example, the computer-readable storage medium may be the computer-readable storage medium 820. It may be understood that the computer-readable storage medium 820 herein may include a built-in storage medium in the electronic device 800 and certainly may also include an extended storage medium supported by the electronic device 800. A computer-readable storage medium provides storage space, and the storage space stores an operating system of the electronic device 800. In addition, one or more computer instructions suitable for being loaded and executed by the processor 810 are further stored in the storage space. These computer instructions may be one or more computer programs 821 (including program code).

According to another aspect of this application, this application further provides a computer program product or a computer program, where the computer program product or the computer program includes a computer instruction, and the computer instruction is stored in a computer-readable storage medium. For example, the computer program may be the computer program 821. In this case, the data processing device 800 may be a computer. The processor 810 reads the computer instruction from the computer-readable storage medium 820, and the processor 810 executes the computer instruction, so that the computer executes the encoding method or the decoding method provided in the foregoing optional manners. In other words, when software is used to implement embodiments, the foregoing embodiments may be implemented completely or partially in a form of a computer program product. The computer program product includes one or more computer instructions. When the computer program instructions are loaded and executed on the computer, procedures of embodiments of this application are completely or partially run, or functions of embodiments of this application are implemented. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner.

According to another aspect of this application, this application further provides a bitstream, where the bitstream may be a bitstream decoded by using the decoding method provided in this application or a bitstream generated by using the encoding method provided in this application.

A person of ordinary skill in the art may be aware that units and procedure steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

Finally, it should be noted that the foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A decoding method, comprising:
filtering a reconstructed block of a current block, to obtain a first filtered block;
determining a first residual block based on the first filtered block and the reconstructed block;
adjusting a direct current component of the first residual block, to obtain a second residual block; and
determining a final reconstructed block of the current block based on the second residual block and the reconstructed block.

2. The method according to claim 1, wherein the determining the first residual block based on the first filtered block and the reconstructed block comprises:
decoding a bitstream to determine a first identifier; and
in a case that the first identifier indicates adjusting a filtered image corresponding to a current image to which the current block belongs, determining the first residual block based on the first filtered block and the reconstructed block.

3. The method according to claim 2, wherein the decoding the bitstream to determine the first identifier comprises:
decoding the bitstream to determine a second identifier; and
in a case that the second identifier indicates adjusting a filtered image corresponding to an image in an image sequence to which the current image belongs, decoding the bitstream to determine the first identifier.

4. The method according to claim 1, wherein the adjusting the direct current component of the first residual block, to obtain the second residual block comprises:
determining an adjustment value based on at least one sample residual value in the first residual block; and
subtracting the adjustment value from a sample residual value in the at least one sample residual value, to obtain the second residual block.

5. The method according to claim 4, wherein the at least one sample residual value comprises all sample residual values in the first residual block.

6. The method according to claim 4, wherein the at least one sample residual value comprises a non-zero sample residual value in the first residual block, or the at least one sample residual value comprises a sample residual value in each of at least one group obtained by dividing sample residual values in the first residual block according to at least one predefined value range.

7. The method according to claim 1, wherein the adjusting the direct current component of the first residual block, to obtain the second residual block comprises:
determining a first residual image based on the first residual block and at least one residual block,
wherein the at least one residual block comprises a residual block determined based on a filtered block obtained by filtering a first block and a reconstructed block of the first block, and the first block is an image block in a current image to which the current block belongs;
determining an adjustment value based on at least one sample residual value in a sliding window in the first residual image; and
subtracting the adjustment value from a sample residual value in the at least one sample residual value, to obtain a residual image that comprises the second residual block.

8. The method according to claim 7, wherein the at least one sample residual value comprises all sample residual values within the sliding window.

9. The method according to claim 7, wherein the at least one sample residual value comprises a non-zero sample residual value in the sliding window, or the at least one sample residual value comprises a sample residual value in each of at least one group obtained by dividing sample residual values in the sliding window according to at least one predefined value range.

10. The method according to claim 4, wherein the determining the adjustment value comprises:
determining an average value of the at least one sample residual value or a value obtained by performing a rounding operation on the average value of the at least one sample residual value as the adjustment value.

11. The method according to claim 4, wherein the determining the adjustment value comprises:
determining the adjustment value based on an average value of the at least one sample residual value and a preset first value range.

12. The method according to claim 11, wherein the determining the adjustment value based on the average value of the at least one sample residual value and the preset first value range comprises:
in a case that the average value is within the first value range, determining the average value or a value obtained by performing a rounding operation on the average value as the adjustment value; or
in a case that the average value is greater than an upper limit of the first value range, determining the upper limit as the adjustment value; or
in a case that the average value is less than a lower limit of the first value range, determining the lower limit as the adjustment value.

13. The method according to claim 1, wherein the filtering the reconstructed block of the current block, to obtain the first filtered block comprises:
filtering the reconstructed block by using any one of following filters, to obtain the first filtered block:
a deblocking filter, a sample adaptive offset filter, an adaptive loop filter, or a neural network based loop filter.

14. An encoding method, comprising:
filtering a reconstructed block of a current block, to obtain a first filtered block;
determining a first residual block based on the first filtered block and the reconstructed block;
adjusting a direct current component of the first residual block, to obtain a second residual block;
determining a second filtered block based on the second residual block and the reconstructed block; and
determining a filtered image with a smaller rate distortion cost among a first filtered image to which the first filtered block belongs and a second filtered image to which the second filtered block belongs, as a reconstructed image of a current image to which the current block belongs.

15. The method according to claim 14, wherein the method further comprises:
encoding a first identifier,
wherein when a rate distortion cost of the first filtered image is less than or equal to a rate distortion cost of the second filtered image, the first identifier indicates not adjusting a filtered image corresponding to the current image to which the current block belongs; or when a rate distortion cost of the first filtered image is greater than a rate distortion cost of the second filtered image, the first identifier indicates adjusting a filtered image corresponding to the current image.

16. The method according to claim 14, wherein the method further comprises:
encoding a second identifier,
wherein the second identifier indicates adjusting or not adjusting a filtered image corresponding to an image in an image sequence to which the current image belongs.

17. The method according to claim 14, wherein the adjusting the direct current component of the first residual block, to obtain the second residual block comprises:
determining an adjustment value based on at least one sample residual value in the first residual block; and
subtracting the adjustment value from a sample residual value in the at least one sample residual value, to obtain the second residual block.

18. The method according to claim 17, wherein the at least one sample residual value comprises all sample residual values in the first residual block.

19. A decoder, comprising: a memory and a processor, wherein the memory is configured to store a computer program, and the processor is configured to execute the computer program stored in the memory to cause the decoder to perform a decoding method comprising:
filtering a reconstructed block of a current block, to obtain a first filtered block;
determining a first residual block based on the first filtered block and the reconstructed block;
adjusting a direct current component of the first residual block, to obtain a second residual block; and
determining a final reconstructed block of the current block based on the second residual block and the reconstructed block.

20. A non-transitory computer-readable storage medium storing a computer program/instruction and a bitstream, wherein the computer program/instruction is executed by a processor to perform the encoding method according to claim 14 to generate the bitstream.
